(19) United States
(12) Patent Application Publication
(10) Pub. No.: US 2025/0204516 A1
(43) Pub. Date: Jun. 26, 2025

(54) SYSTEMS AND METHODS FOR NORMOTHERMIC EX-VIVO PERFUSION OF THE PANCREAS

(71) Applicant: University Health Network, Toronto (CA)

(72) Inventors: Trevor William REICHMAN, Toronto (CA); Justin MANUEL, Hamilton (CA); Catherine PARMENTIER DE LEÓN, Etobicoke (CA); Samrat RAY, Toronto (CA); Markus SELZNER, Toronto (CA); Laura Ioana MAZILESCU, Essen (DE); Sujani GAVASCGAR, Pickering (CA)

(73) Assignee: University Health Network, Toronto (CA)

(21) Appl. No.: 18/986,191

(22) Filed: Dec. 18, 2024

Related U.S. Application Data
(60) Provisional application No. 63/612,688, filed on Dec. 20, 2023.

(51) Int. Cl. A01N 1/143; A01N 1/126; A01N 1/144; A01N 1/162; A01N 1/165

(52) U.S. Cl. CPC A01N 1/143; A01N 1/126; A01N 1/144; A01N 1/162; A01N 1/165

(57) ABSTRACT

A normothermic machine perfusion method for a pancreas is provided. First, a perfusate contained in a venous reservoir may be oxygenated such that a ratio of oxygen to carbon dioxide in the oxygenated perfusate is approximately 90%/10%. A first portion of the oxygenated perfusate may be pumped from the venous reservoir, through a dialysis filter, and back to the venous reservoir. A dialysate comprising a salt and glucose may be infused into the first portion of the oxygenated perfusate as the first portion is pumped through the dialysis filter. A concentration of glucose in the dialysate may be less than 8 mmol/L. A second portion of the oxygenated perfusate may be pumped through an arterial filter and through a pancreas graft. Venous outflow from the pancreas graft may then be pumped to the venous reservoir.

### CROSS-REFERENCE TO RELATED APPLICATION

This application claims the benefit of U.S. Provisional Application No. 63/612,688, filed Dec. 20, 2023, the entire contents of which are incorporated herein by reference.

### FIELD

The present disclosure relates generally to techniques for preserving pancreas grafts following retrieval from donors, and, in particular, to techniques for performing normothermic ex-vivo perfusion of pancreas grafts.

### BACKGROUND

Diabetes impacts a vast number of individuals worldwide and is considered to be a major global health concern. Severe hypoglycemic episodes, which most commonly occur in people with type 1 diabetes, are life-threatening situations, particularly for individuals with hypoglycemic unawareness.

Pancreas transplantation is the most effective treatment option for individuals suffering from hypoglycemic unawareness. However, the pancreas is a complex organ and, as such, has the highest discard rate after retrieval compared to other organs. The numerous factors that can influence a transplant center's decision to discard a donated pancreas graft, including donor age, donor BMI, donation after cardiac death (DCD), history of alcohol abuse, history of pancreatitis and pancreatic trauma, have significantly restricted the pancreas donor pool.

### SUMMARY

Due to its superiority to static cold storage (SCS) for preserving organs such as lungs, kidney, liver, and heart, normothermic ex-vivo perfusion (NEVP) has emerged as promising strategy to assess and potentially improve a pancreas graft prior to transplantation. Described herein are systems and methods for NEVP of pancreas grafts that utilize a perfusate configured to augment vascular flow through the pancreas graft and minimize graft injury and edema. The provided techniques can increase the feasibility of graft transplantation, even in grafts subjected to prolonged (e.g., greater than 21 hours) cold ischemia. As a result, the disclosed systems and methods may substantially reduce the frequency at which pancreas grafts are discarded following retrieval from donors.

The techniques described herein may use a perfusion circuit to pump perfusate through a donated pancreas graft. As the perfusate is circulated, oxygen and carbon dioxide may be provided to the perfusate at concentrations of approximately 90% and 10%, respectively. The 90%/10% oxygen/carbon dioxide ratio may enable the vasodilation effects of the carbon dioxide to be leveraged in order to improve blood flow in the graft while maintaining oxygen levels in the pancreas graft that are sufficient to prevent tissue death but low enough to minimize oxidative stress on the graft.

Following oxygenation, a portion of the oxygenated perfusate may be pumped through a dialysis filter, where a dialysate comprising a salt may be infused. The salt in the dialysate may reduce the amount of edema that develops in the graft during perfusion. To further reduce stress on the graft, glucose levels in the dialysate may be limited to a concentration of approximately 5 mmol/L.

A normothermic machine perfusion method for a pancreas provided herein may comprise oxygenating a perfusate contained in a venous reservoir such that a ratio of oxygen to carbon dioxide in the oxygenated perfusate is approximately 90%/10%, pumping a first portion of the oxygenated perfusate from the venous reservoir, through a dialysis filter, and back to the venous reservoir, infusing a dialysate comprising a salt and glucose, into the first portion of the oxygenated perfusate as the first portion is pumped through the dialysis filter, wherein a concentration of glucose in the dialysate is less than 8 mmol/L, pumping a second portion of the oxygenated perfusate through an arterial filter and through a pancreas graft, and pumping venous outflow from the pancreas graft to the venous reservoir. A concentration of salt in the dialysate may be between 0.5 g/L and 5 g/L, for example approximately 1.5 g/L. The concentration of glucose in the dialysate may be less than 6 mmol/L, for example approximately 5.5 mmol/L. The dialysate may be infused at a rate of 1 L/hr. The second portion of the oxygenated perfusate may be pumped through the pancreas graft at a rate greater than or equal to 90 mL/min and less than or equal to 125 mL/min.

A bolus of a vasodilator may be added to the second portion of the oxygenated perfusate after the second portion is pumped through the arterial filter. The vasodilator may be a calcium channel blocker. The bolus may be 5 mg/2 mL.

The perfusate may comprise at least one antibiotic. The at least one antibiotic may comprise metronidazole, cefazolin, or combination thereof. If the at least one antibiotic comprises metronidazole and cefazolin, a ratio of an amount of metronidazole to an amount of cefazolin may be 0.5.

The method can further include monitoring an arterial pressure in the pancreas graft as the second portion of the oxygenated perfusate is pumped through the graft and adjusting a flow rate of the second portion of the oxygenated perfusate through the pancreas graft based on the arterial pressure. The flow rate of the second portion of the oxygenated perfusate may be adjusted such that the arterial pressure is maintained between 15 mmHg and 27 mmHg.

The normothermic machine perfusion method may be performed after the pancreas graft was held in cold storage for at least 15 hours. Following perfusion, islets may be extracted from the pancreas graft, or at least a portion of the pancreas graft may be transplanted.

A system for normothermic machine perfusion of a pancreas provided herein may include a perfusate, a venous reservoir for containing the perfusate, an oxygenator connected to the venous reservoir and configured to produce oxygenated perfusate, wherein a ratio of oxygen to carbon dioxide in the oxygenated perfusate is approximately 90%/10%. a dialysis filter connected to the venous reservoir and configured to infuse a dialysate comprising a salt and glucose into a first portion of the oxygenated perfusate, an arterial filter for filtering a second portion of the oxygenated perfusate, a chamber for containing a pancreas graft connected to the venous reservoir and the arterial filter, and a pump for transporting the perfusate from the venous reservoir to the oxygenator, transporting the first portion of the oxygenated perfusate through the dialysis filter, transporting the second portion of the oxygenated perfusate through the arterial filter and through the pancreas graft in the chamber, and transporting venous outflow from the pancreas graft in the chamber to the venous reservoir. A concentration of salt in the dialysate may be between 0.5 g/L and 5 g/L, for example approximately 1.5 g/L. The concentration of glucose in the dialysate may be less than 6 mmol/L, for example approximately 5.5 mmol/L.

### BRIEF DESCRIPTION OF THE FIGURES

The following figures show various systems and methods for normothermic ex-vivo perfusion (NEVP) of pancreas grafts, along with example data collected from pancreas grafts perfused using said systems and methods. The systems and methods shown in the figures may have any one or more of the characteristics described herein.

FIG. 1 shows a system for NEVP of a pancreas, according to some embodiments.

FIG. 2 shows a method for NEVP of a pancreas, according to some embodiments.

FIG. 3 shows a photograph of a human pancreas graft following a back-table preparation process, according to some embodiments.

FIG. 4A shows a photograph of a human pancreas graft prior to perfusion according to the provided techniques.

FIG. 4B shows a photograph of a human pancreas graft following perfusion according to the provided techniques.

FIG. 5A shows amylase values measured during perfusion of porcine pancreas grafts.

FIG. 5B shows LDH values measured during perfusion of porcine pancreas grafts.

FIG. 5C shows glucose levels measured during perfusion of porcine pancreas grafts.

FIG. 5D shows lactate values measured during perfusion of porcine pancreas grafts.

FIG. 5E compares amylase values measured in porcine serum after transplantation of pancreas grafts preserved using the provided NEVP techniques and amylase values measured in porcine serum after transplantation of pancreas grafts preserved using a conventional cold storage technique.

FIG. 5F compares lipase values measured in porcine serum after transplantation of pancreas grafts preserved using the provided NEVP techniques and lipase values measured in porcine serum after transplantation of pancreas grafts preserved using a conventional cold storage technique.

FIG. 5G compares LDH values measured in porcine serum after transplantation of pancreas grafts preserved using the provided NEVP techniques and LDH values measured in porcine serum after transplantation of pancreas grafts preserved using a conventional cold storage technique.

FIG. 5H compares lactate values measured in porcine blood after transplantation of pancreas grafts preserved using the provided NEVP techniques and lactate values measured in porcine blood after transplantation of pancreas grafts preserved using a conventional cold storage technique.

FIG. 5I compares glucose values measured in porcine blood after transplantation of pancreas grafts preserved using the provided NEVP techniques and glucose values measured in porcine blood after transplantation of pancreas grafts preserved using a conventional cold storage technique.

FIG. 5J compares glucose values measured in porcine blood during a glucose tolerance test after transplantation of pancreas grafts preserved using the provided NEVP techniques and glucose values measured in porcine blood during a glucose tolerance test after transplantation of pancreas grafts preserved using a conventional cold storage technique.

FIG. 5K compares C-peptide values measured in porcine serum after transplantation of pancreas grafts preserved using the provided NEVP techniques and C-peptide values measured in porcine serum after transplantation of pancreas grafts preserved using a conventional cold storage technique.

FIG. 5L compares 8-hydroxydeoxyguanosine values measured in porcine serum after transplantation of pancreas grafts preserved using the provided NEVP techniques and 8-hydroxydeoxyguanosine values measured in porcine serum after transplantation of pancreas grafts preserved using a conventional cold storage technique.

FIG. 5M compares TUNEL values measured in porcine pancreas grafts preserved using the provided NEVP techniques and TUNEL values measured in porcine pancreas grafts preserved using a conventional cold storage technique.

FIG. 6A shows mean wet/dry weight ratio values for human pancreas grafts measured before and after perfusion using the provided NEVP techniques.

FIG. 6B shows wet/dry weight ratio values for human pancreas grafts measured before and after perfusion using the provided NEVP techniques.

FIG. 6C shows amylase values measured during perfusion of human pancreas grafts.

FIG. 6D shows glucose values measured during perfusion of human pancreas grafts.

FIG. 6E shows lactate values measured during perfusion of human pancreas grafts.

FIG. 6F shows C-peptide values measured during perfusion of human pancreas grafts.

FIG. 6G shows insulin values measured during perfusion of human pancreas grafts.

FIG. 6H shows pH values measured during perfusion of human pancreas grafts.

FIG. 6I shows HCO3 values measured during perfusion of human pancreas grafts.

FIG. 6J shows pCO2 values measured during perfusion of human pancreas grafts.

FIG. 6K shows pO2 values measured during perfusion of human pancreas grafts.

FIG. 6L shows mean arterial flow values measured during perfusion of human pancreas grafts.

FIG. 6M shows arterial flow values measured during perfusion of human pancreas grafts.

FIG. 6N shows intra-vascular resistance values measured during perfusion of human pancreas grafts.

FIG. 6O shows H&E staining of human pancreas tail biopsies provided with (i) CO₂ 5% during perfusion, (ii) CO₂ 5% at 1 h of perfusion, (iii) CO₂ 5% at the end of 4 h of perfusion, (iv) CO₂ 9% during perfusion, (v) CO₂ 9% at 1 h of perfusion, and (vi) CO₂ 9% at the end of 4 h of perfusion.

FIG. 6P shows insulin staining of human pancreas biopsies at the end of perfusion for (i) case 1 (ii) case 2 (iii) case 3 (iv) case 4 (v) case 5, and (vi) case 6 of Example 2 provided in the Detailed Description.

FIG. 6Q shows TUNEL staining of human pancreas biopsies for (i) a positive and negative control and for (ii) case 1 (iii) case 2 (iv) case 3 (v) case 4 (vi) case 5, and (vii) case 6 of Example 2 provided in the Detailed Description.

FIG. 6R shows CD31 staining of human pancreas biopsies at the end of perfusion for (i) case 1 (ii) case 2 (iii) case 3 (iv) case 4 (v) case 5, and (vi) case 6 of Example 2 provided in the Detailed Description.

FIG. 6S shows MDA levels measured by a TBARS assay in human pancreas grafts.

FIG. 7A shows pre-purification islets in a human pancreas graft preserved using the provided NEVP techniques.

FIG. 7B shows post-purification islets in a human pancreas graft preserved using the provided NEVP techniques.

FIG. 7C shows H&E staining in a human pancreas graft preserved using the provided NEVP techniques.

FIG. 7D shows insulin staining in a human pancreas graft preserved using the provided NEVP techniques.

FIG. 7E shows results from a glucose-stimulated insulin secretion test performed on a human pancreas preserved using the provided NEVP techniques.

FIG. 7F shows results from a glucose-stimulated insulin secretion test performed on a human pancreas preserved using the provided NEVP techniques.

FIG. 8A shows an example experimental protocol for studying the effects of the provided NEVP techniques on porcine pancreas grafts that were subjected to prolonged cold ischemia.

FIG. 8B shows D-dimer levels in porcine pancreas grafts that were subjected to only to prolonged cold storage and D-dimer levels in porcine pancreas grafts that were subjected to prolonged cold storage and then preserved using the provided NEVP techniques.

FIG. 8C shows a plot of arterial pressure during NEVP in porcine pancreas grafts that had been subjected to prolonged cold ischemia.

FIG. 8D shows a plot of arterial flow during NEVP in porcine pancreas grafts that had been subjected to prolonged cold ischemia.

FIG. 8E shows a plot of intravascular resistance during NEVP in porcine pancreas grafts that had been subjected to prolonged cold ischemia.

FIG. 8F shows a plot of partial pressure of oxygen in a perfusate used during NEVP of porcine pancreas grafts that had been subjected to prolonged cold ischemia.

FIG. 8G shows a plot of perfusate lactate levels in a perfusate used during NEVP of porcine pancreas grafts that had been subjected to prolonged cold ischemia.

FIG. 8H shows serum CPK levels in porcine pancreas grafts that were subjected only to prolonged cold storage and serum CPK levels in porcine pancreas grafts that were subjected to prolonged cold storage and then perfused using the provided NEVP techniques.

FIG. 8I shows LDH levels in porcine pancreas grafts that were subjected only to prolonged cold storage and LDH levels in porcine pancreas grafts that were subjected to prolonged cold storage and then perfused using the provided NEVP techniques.

FIG. 8J shows photographs of porcine pancreas grafts that were subjected only to prolonged cold storage and photographs of porcine pancreas grafts that were subjected to prolonged cold storage and then perfused using the provided NEVP techniques.

FIG. 8K shows H&E staining at necropsy of the pancreas parenchyma (corpus) of a porcine pancreas graft that was subjected only to prolonged cold storage and H&E staining at necropsy of the pancreas parenchyma (corpus) of porcine pancreas grafts that were subjected to prolonged cold storage and then perfused using the provided NEVP techniques.

FIG. 8L shows H&E staining at necropsy of the duodenum of a porcine pancreas graft that was subjected only to prolonged cold storage and H&E staining at necropsy of the duodenum (corpus) of porcine pancreas grafts that were subjected to prolonged cold storage and then perfused using the provided NEVP techniques.

FIG. 8M show TUNEL staining at necropsy of the pancreas parenchyma (corpus) of a porcine pancreas graft that was subjected only to prolonged cold storage and TUNEL staining at necropsy of the pancreas parenchyma (corpus) of porcine pancreas grafts that were subjected to prolonged cold storage and then perfused using the provided NEVP techniques.

### DETAILED DESCRIPTION

Described herein are systems and methods for NEVP of pancreas grafts that utilize a perfusate configured to simulate a physiological environment for the pancreas graft. The perfusate may be configured to augment vascular flow through the pancreas graft and minimize graft injury and edema. The provided techniques can increase the feasibility of graft transplantation, even in grafts subjected to prolonged (e.g., greater than 21 hours) cold ischemia. As a result, the disclosed systems and methods may substantially reduce the frequency at which pancreas grafts are discarded following retrieval from donors.

The techniques described herein may use a perfusion circuit to pump perfusate through a donated pancreas graft. As the perfusate is circulated, oxygen and carbon dioxide may be provided to the perfusate at concentrations of approximately 90% and 10%, respectively. The 90%/10% oxygen/carbon dioxide ratio may enable the vasodilation effects of the carbon dioxide to be leveraged in order to improve blood flow in the graft while maintaining oxygen levels in the pancreas graft that are sufficient to prevent tissue death but low enough to minimize oxidative stress on the graft. Following oxygenation, a portion of the oxygenated perfusate may be pumped through a dialysis filter, where a dialysate comprising a salt may be infused. The salt in the dialysate may reduce the amount of edema that develops in the graft during perfusion. To further reduce stress on the graft, glucose levels in the dialysate may be limited to a concentration of approximately 5 mmol/L.

Various embodiments of the disclosed systems and methods may be non-inferior or superior to conventional preservation strategies such as static cold storage. In some cases, the systems and methods can be used to rescue and reanimate grafts for transplantation. The provided techniques may feasible and safe for use in preserving human pancreases and have the potential to significantly expand the pancreas donor pool.

### Definitions

Any of the systems, methods, techniques, and/or features disclosed herein may be combined, in whole or in part, with any other systems, methods, techniques, and/or features disclosed herein.

As used herein, the singular forms “a”, “an”, and “the” include the plural reference unless the context clearly dictates otherwise.

Reference to “about” or “approximately” a value or parameter herein includes (and describes) variations of that value or parameter per se. For example, description referring to “approximately X” or “about X” includes description of “X” as well as variations of “X”.

When a range of values or values is provided, it is to be understood that each intervening value between the upper and lower limit of that range, and any other stated or intervening value in that stated range, is encompassed within the scope of the present disclosure. Where the stated range includes upper or lower limits, ranges excluding either of those included limits are also included in the present disclosure.

The term “pancreas graft” used herein is to be understood to include any portion of a pancreas, including the entire organ or a piece of the organ.

### NEVP System and Method

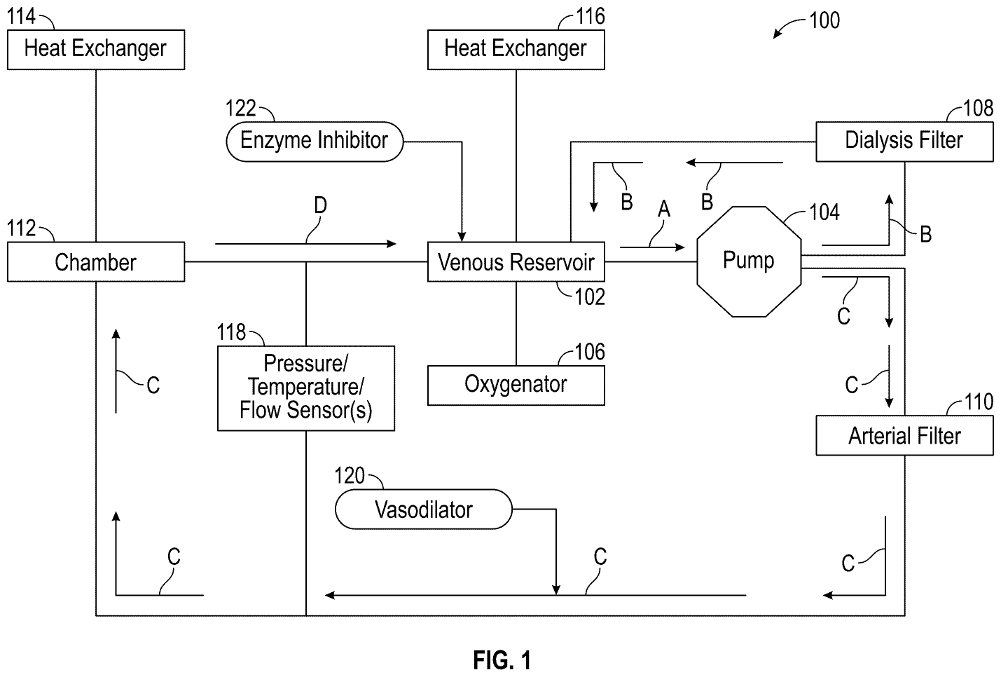

FIG. 1 shows an exemplary system 100 for normothermic ex-vivo perfusion of pancreas grafts. System 100 may include a venous reservoir 102 for containing a perfusate, a centrifugal pump 104 for circulating the perfusate through system 100, an oxygenator 106 for providing oxygen and carbon dioxide to the perfusate, a dialysis filter (or dialysis cassette) 108 for dialyzing the perfusate, an arterial filter 110 for removing emboli and other debris from the perfusate, and a chamber 112 for containing the pancreas graft. Heat exchangers 114 and 116 may maintain venous reservoir 102 and chamber 112 at workable temperatures (e.g., between about 34 degrees Celsius and about 39 degrees Celsius, for example about 38 degrees Celsius). Tubing may fluidically couple venous reservoir 102, pump 104, dialysis filter 108, arterial filter 110, and a pancreas graft container in chamber 112. In some embodiments, system 100 comprises one or more sensors 118 for monitoring various perfusate parameters, including perfusate temperature, perfusate pressure, and perfusate flow rate.

The total amount of perfusate used during perfusion may be between 100 mL and 1000 mL, between 200 mL and 900 mL, between 300 mL and 700 mL, between 400 mL and 675 mL, between 500 mL and 670 mL, or between 600 mL and 660 mL. For example, the total amount of perfusate may be approximately 650 mL, 651 mL, 652 mL, 653 mL, 654 mL, 655 mL, 656 mL, 657 mL, 658 mL, or 659 mL. In some embodiments, the total amount of perfusate may be less than 100 mL or greater than 1000 mL.

For perfusion of a human pancreas, the perfusate may be a solution comprising STEEN solution, packed red blood cells (PRBC), NaHCO₃ (8.4%), heparin (10,000 IU/mL), and epoprostenol. An enzyme inhibitor 122 (e.g., aprotinin), along with a vasodilator (e.g., epoprostenol) may be added to the perfusate in venous reservoir 102 at continuous rates. Example amounts of each ingredient needed to produce about 656 mL of perfusate are provided in Table 1.

TABLE 1
Example perfusate ingredients and
amounts (makes 656 mL of perfusate)

| Ingredient | Amount | |
|---|---|---|
| STEEN solution | 215 | mL |
| PRBC | 400 | mL |
| NaHCO₃ (8.4%) | 10 | mL |
| Heparin (10,000 IU/mL) | 1.3 | mL |

| | |
|---|---|
| Aprotinin | 15 mg in the reservoir |
| | 15 mg as continuous infusion |
| Epoprostenol | 0.5 mg in 250 mL of ringer's lactate at 8 |
| | mL/h |

The perfusate may include an antibiotic or a combination of antibiotics. For example, the perfusate can comprise a combination of metronidazole and cefazolin. The ratio of metronidazole to cefazolin in the perfusate may be between ¼ and ½, between ⅓ and ⅔, or between ½ and ¾. In some embodiments, about 756 mL of perfusate may contain approximately 400 mg, 425 mg, 450 mg, 475 mg, 500 mg, 525 mg, 550 mg, 575 mg, or 600 mg of metronidazole and approximately 900 mg, 925 mg, 950 mg, 975 mg, 1000 mg, 1025 mg, 1050 mg, 1075 mg, or 2000 mg of cefazolin.

While developing the disclosed techniques, the inventors unexpectedly discovered that providing oxygen and carbon dioxide to the perfusate at an oxygen/carbon dioxide ratio of approximately 90%/10% can facilitate blood flow in the graft while reducing oxidative stress on the graft. Accordingly, during perfusion, the perfusate contained in venous reservoir 102 may be driven to oxygenator 106 by pump 104. Oxygenator 106 may provide oxygen and carbon dioxide to the perfusate at concentrations configured to increase the vasodilation effects of the carbon dioxide to improve blood flow in the pancreas graft while simultaneously maintaining oxygen levels in the pancreas graft that are sufficient to prevent tissue death but low enough to minimize oxidative stress on the graft. In various embodiments, the oxygen/carbon dioxide ratio provided to the perfusate by oxygenator 106 is between 88/12% and 93/7%, between 89/11% and 92/8%, between 89/11% and 91/9%, or between 90/10% and 91/9%. For example, the oxygen/carbon dioxide ratio provided to the perfusate by oxygenator 106 may be 89/11%, 89.1/10.9%, 89.2/10.8%, 89.3/10.7%. 89.4/10.6%, 89.5/10.5%, 89.6/10.4%, 89.7/10.3%, 89.8/10.2%, 89.9/10.1%, 90/10%, 90.1/9.9%, 90.2/9.8%, 90.3/9.7%. 90.4/9.6%, 90.5/9.5%, 90.6/9.4%, 90.7/9.3%, 90.8/9.2%, 90.9/9.1%, 91/9%, 91.1/8.9%, 91.2/8.8%, 91.3/8.7%. 91.4/8.6%, 91.5/8.5%, 91.6/8.4%, 91.7/8.3%, 91.8/8.2%, 91.9/8.1%, or 92/8%.

Following oxygenation by oxygenator 106, the oxygenated perfusate (indicated by arrow A in FIG. 1) may be divided into a first portion (indicated by arrow B) and a second portion (indicated by arrow C). The first portion of the oxygenated perfusate may be transported through dialysis filter 108 and infused with a dialysate. The rate of dialysate infusion may be approximately 0.5 L/h, 0.75 L/h, 1 L/h, 1.25 L/h, 1.5 L/h, 1.75 L/h, or 2 L/h. For perfusion of a human pancreas, the dialysate may be a solution comprising 45× concentrated hemodialysis solution, NaHCO₃ (8.4%), KHCO₃, and sodium pyruvate. Example amounts of each ingredient in 1 L of dialysate are provided in Table 2.

TABLE 2
Example dialysate (1 L) ingredients and amounts

| Ingredient | Amount | |
|---|---|---|
| 45X dialysis concentrate | 22 | mL |
| NaHCO₃ (8.4%) | 27 | mL |
| KHCO₃ | 3 | mL |
| Sodium pyruvate | 275 | mg |

The glucose concentration in the dialysis concentrate may be restricted in order to minimize strain on the pancreas graft. In some embodiments, the concentration of glucose in the dialysis concentrate is between 3.5 and 8 mmol/L, between 4 and 7 mmol/L, or between 5 and 6 mmol/L. For instance, the glucose concentration in the dialysis concentrate may be approximately 4.5 mmol/L, 4.6 mmol/L, 4.7 mmol/L, 4.8 mmol/L, 4.9 mmol/L, 5 mmol/L, 5.1 mmol/L, 5.2 mmol/L, 5.3 mmol/L, 5.4 mmol/L 5.5 mmol/L, 5.6 mmol/L, 5.7 mmol/L, 5.8 mmol/L, 5.9 mmol/L or 6 mmol/L.

To reduce edema in the pancreas graft, the dialysate contain salt (e.g., NaCl or any other suitable salt). The salt concentration in the dialysate may be between 0.1 g/L and 2 g/L, between 0.25 g/L and 1.75 g/L, between 0.5 g/L and 1.75 g/L, between 0.75 g/L and 1.75 g/L, between 1 g/L and 1.75 g/L, or between 1.25 g/L and 1.75 g/L. For example, the salt concentration in the dialysate may be approximately 0.5 g/L, 0.6 g/L, 0.7 g/L, 0.8 g/L, 0.9 g/L, 1 g/L, 1.1 g/L, 1.2 g/L, 1.3 g/L, 1.4 g/L, 1.5 g/L, 1.6 g/L, 1.7 g/L, 1.8 g/L, 1.9 g/L, 2 g/L.

After the first portion of the oxygenated perfusate is transported through dialysis filter 108, the first portion of the oxygenated perfusate may be returned to venous reservoir 102. The second portion of the oxygenated perfusate may be pumped through arterial filter 110 and to the pancreas graft contained in chamber 112. Between arterial filter 110 and chamber 112, a vasodilator 120 (e.g., verapamil) may be added to the perfusate. The vasodilator bolus may comprise between 2 mg and 18 mg per 2 mL to 6 mL, for example approximately 3 mg, 4 mg, 5 mg, 6 mg, 7 mg, 8 mg, 9 mg, 10 mg, 11 mg, 12 mg, 13 mg, 14 mg, 15 mg, or 16 mg per 2 mL to 6 mL. Venous outflow from the pancreas graft (indicated by arrow D in FIG. 1) may be transported back to venous reservoir 102.

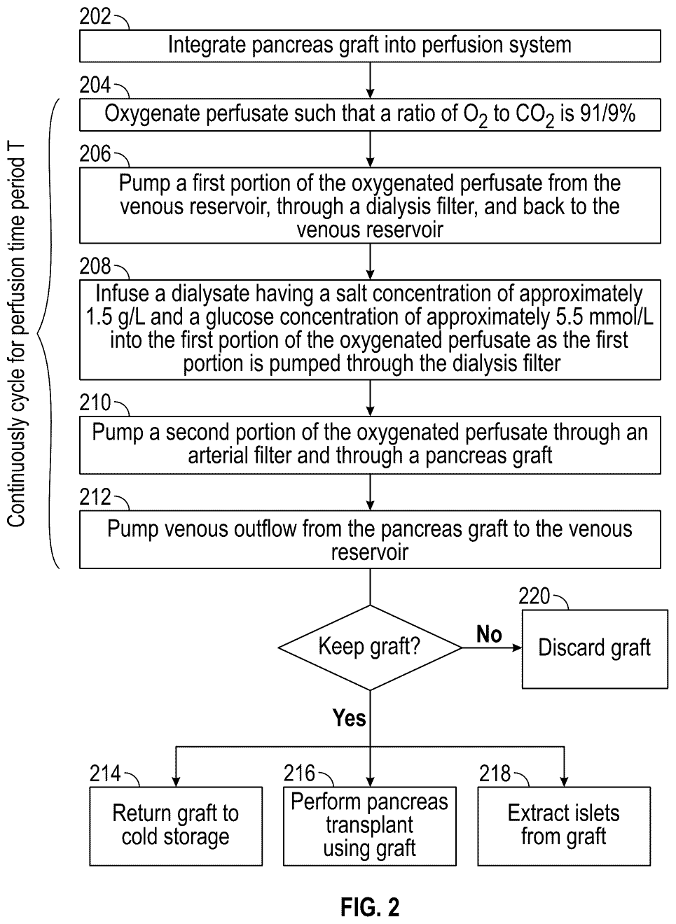

An exemplary method 200 for NEVP of a pancreas graft using the provided system (e.g., system 100) is shown in FIG. 2. First, before perfusion is initiated, the pancreas graft may be prepared and integrated into the perfusion system (step 202). Preparation for perfusion may occur after the graft has been subjected to a period of cold ischemia. In various embodiments, this period of cold ischemia is at least 2 hours, at least 4 hours, at least 6 hours, at least 8 hours, at least 10 hours, at least 12 hours, at least 14 hours, at least 16 hours, at least 18 hours, at least 20 hours, or at least 21 hours.

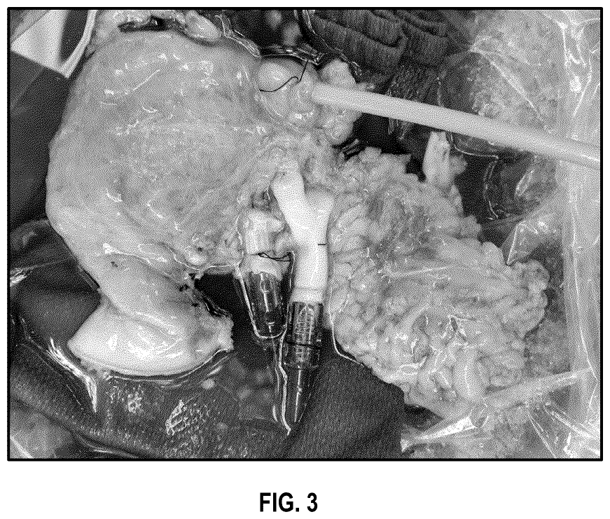

For discarded human pancreas grafts, a back-table preparation process may be employed to prepare and integrate the graft into the system. The graft may first be inspected for any significant damage that would affect the perfusion. The spleen may then be removed by ligating the splenic artery and vein close to the hilum of the spleen. Iliac vessels can be recovered from the donor and any small branches can be suture ligated. Arterial reconstruction may be performed using the donor iliac artery as a “Y graft.” The external iliac artery and internal iliac artery may be respectively anastomosed to the splenic artery and the superior mesenteric artery (e.g., with a 6-0 polypropylene suture). The common iliac artery may then be used for cannulation. An iliac vein may be used as an extension graft by anastomosing the iliac vein to the graft portal vein in an end-to-end fashion (e.g., using a 6-0 polypropylene suture). The artery and vein may be cannulated (e.g., with ¼″×⅜″ reducers). If necessary, the bowel may be shortened and a Malecot catheter may be inserted into the distal end to collect duodenal and pancreatic exocrine output during perfusion. After completion of the back-table process, the pancreas may be weighed and then flushed (e.g., with between 200 mL and 500 mL of 5% albumin). A photograph of a prepared human pancreas graft is provided in FIG. 3.

Once the graft is prepared and integrated into the NEVP system, perfusion may begin. Perfusate contained in a venous reservoir (e.g., venous reservoir 102 shown in FIG. 1) may be oxygenated using an oxygenator (e.g., oxygenator 104 shown in FIG. 1) (step 204). As previously noted, the oxygen/carbon dioxide ratio provided to the perfusate by the oxygenator may be configured to improve blood flow in the pancreas graft and maintain oxygen levels in the pancreas graft that are sufficient to prevent tissue death but low enough to minimize oxidative stress on the graft. For example, the oxygen/carbon dioxide ratio may be approximately 90/10%. A first portion of the oxygenated perfusate may be pumped from the venous reservoir, through a dialysis filter (e.g., dialysis filter 108 shown in FIG. 1), and back to the venous reservoir (step 206). At the dialysis filter, a dialysate configured to reduce graft edema and strain may be infused into the perfusate (step 208). The dialysate may have a salt concentration of approximately 1.5 g/L and a glucose concentration of approximately 5.5 mmol/L. A second portion of the oxygenated perfusate may be transported through an arterial filter (e.g., arterial filter 110 shown in FIG. 1) to remove emboli and other debris and subsequently through the pancreas graft (step 210). Venous outflow from the pancreas graft may be returned to the venous reservoir (step 212).

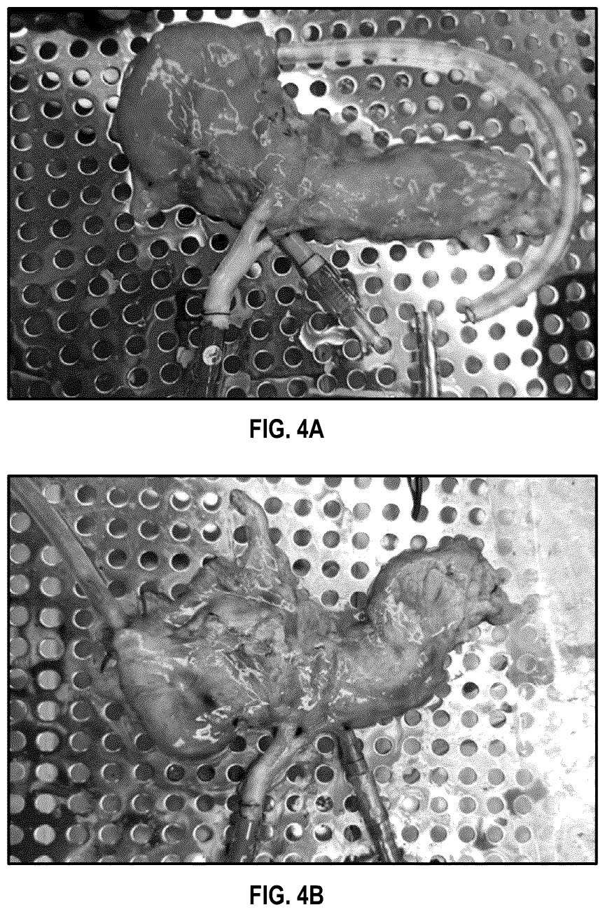

Steps 204-212 of method 200 may be repeated continuously for a predetermined perfusion time T. In some embodiments, the perfusion time is between 5 minutes and 12 hours, between 30 minutes and 10 hours, between 45 minutes and 8 hours, between 1 hour and 5 hours, between 1.5 hours and 4.5 hours, or between 2 hours and 4 hours. For example, the perfusion time may be approximately 2 hours, 2.25 hours, 2.5 hours, 2.75 hours, 3 hours, 3.25 hours, 3.5 hours, 3.75 hours, 4 hours, 4.25 hours, or 4.5 hours. In some embodiments, the perfusion time is less than 5 minutes or greater than 12 hours. At the end of the perfusion time period, circulation of the perfusate through the perfusion system may cease, and the pancreas graft may be disconnected from the system. Photographs of a pancreas graft prior to perfusion and after completion of perfusion are shown in FIGS. 4A and 4B, respectively.

During perfusion, various perfusate parameters may be monitored (e.g., continuously or at regular intervals) to ensure that proper perfusion conditions are maintained. In particular, arterial pressure in the graft may be tracked to prevent the arterial pressure from rising too high or falling too low. Acceptable arterial pressure may be between 10 mmHg and 30 mmHg, between 11 mmHg and 29 mmHg, between 12 mmHg and 28 mmHg, between 13 mmHg and 27 mmHg, between 14 mmHg and 26 mmHg, or between 15 mmHg and 25 mmHg. If the arterial pressure veers outside of the acceptable pressure range, the rate at which the perfusate is pumped through the NEVP system (i.e., the flow rate of the perfusate), may be adjusted accordingly. The flow rate for maintaining acceptable arterial pressure may be between 85 mL/min and 130 mL/min, between 90 mL/min and 130 mL/min, 90 mL/min and 125 mL/min, 90 mL/min and 120 mL/min, 90 mL/min and 115 mL/min, or 90 mL/min and 110 mL/min. The flow rate may be controlled using the pump that circulates the perfusate (e.g., pump 104 shown in FIG. 1). In some embodiments, the pump is controlled automatically (e.g., using a computer system) based on measurements of the arterial pressure and the flow rate.

During and after perfusion, the graft may be evaluated for transplant viability. Evaluation parameters may include wet/dry weight ratio, amylase levels, glucose levels, lactate levels, pH levels, C-peptide levels, insulin levels, HCO₃ levels, pCO2 levels, and oxidative stress levels. If, following perfusion, the graft is determined to be viable, the graft may be returned to cold storage (step 214), used to perform a pancreas transplant (step 216), or used as a source of islets for an islet transplant (step 218). If, on the other hand, the graft is determined to be non-viable, the graft may be discarded (step 220).

### Example 1—NEVP of Porcine Pancreas (1)

In this example, the provided systems and methods were tested using a porcine model and compared to conventional static cold storage (SCS) techniques. A first group (the SCS/control group, consisting of n=3 grafts) of porcine pancreas grafts were preserved for five hours using SCS and a second group (the “NEVP” group, consisting of n=3 grafts) were preserved two hours using SCS followed by three hours using NEVP (NEVP/study group, n=3). Parameters including perfusion values, laboratory values and histopathology were evaluated for both groups. The organs from both groups were transplanted into pigs. The pigs were followed for three days post transplantation and a glucose test was performed before sacrifice. Laboratory values (amylase, lipase, LDH, lactate and glucose) presented no significant differences between the groups. However, apoptosis measured by TUNEL and oxidative stress measured by 8-OHdg were significantly lower in the NEVP group.

### Summary of Experiment

The experiment described in this example utilized male Yorkshire pigs aged 12 to 15 weeks and weighing between 30 and 40 kg. The experiment included two groups: a control group comprising three cases, each involving a donor and a recipient, and a study group comprising three cases, each with a donor and a recipient.

In the control group, pancreas grafts were preserved in SCS for five hours, transplanted, and the animals were followed for three days. In the study group, pancreas grafts were preserved in SCS for 2 hours, NEVP for 3 hours, transplanted, and the animals were followed for three days.

To procure the grafts, the animals were sedated with ketamine (20 mg/kg), midazolam (0.3 mg/kg), and atropine (0.04 mg/kg) and taken to the operating room (OR). Once on the OR table, intubation and central line placement were performed. After the placement of the central line and prior to the start of surgery, 500 mg of metronidazole and 1 g of cefazolin were given as prophylaxis. An infusion of fentanyl (2 μg/kg) was started after the antibiotics and prior to the incision. In addition, an infusion of propofol at 15 ml per hour was added. A midline incision was made, and the inferior vena cava (IVC) and aorta were dissected. Lumbar branches were ligated, and the hepatic hilum was dissected, with the arteries and common bile duct ligated and cut. The suprahepatic portion of the aorta was identified and dissected, and the lesser sac was opened. Animals were heparinized (500 IU per kg of body weight), blood was collected for posterior preparation and use on the machine, and inferior portion of aorta ligated and cannulated. The suprahepatic aorta was cross-clamped and flush with University of Wisconsin (UW) solution initiated, with venting through an opening in the portal vein and in the IVC. The graft was flushed with 2 liters of UW solution.

Dissection of the pancreas began from tail to head, mesenteric vessels were clamped, ligated, and extra pancreatic tissues divided. The graft was then placed on ice with UW solution while back-table was performed to prepare it for SCS or machine perfusion. The back-table for machine perfusion included extending the portal vein using a previously recovered cava or iliac vein and cannulating both proximal end of aorta and extended portal vein. The distal bowel was cannulated with a Malecot catheter and the mesenteric vessels were oversewn with 4-0 polypropylene suture.

Normothermic ex-vivo perfusion was performed using a perfusion system comprising a Sorin Stockert Shiley SIII heart-lung machine and bespoke cardiopulmonary bypass equipment that includes a centrifugal pump, an oxygenator, a venous reservoir, and an arterial bubble filter (Sorin Group). In addition, an F3 hemoflow dialysis filter (Fresenius Medical Care) was incorporated into the system (see FIG. 1 for a block diagram of an exemplary NEVP system).

The perfusate solution was composed of ringer's lactate, STEEN Solution (XVIVO Perfusion AB, Goteborg, Sweden), washed leukocyte-filtered erythrocytes, double reverse osmosis water, sodium bicarbonate, calcium gluconate, heparin and aprotinin. The NEVP system provided a continuous oxygen/carbon dioxide gas mixture at a ratio of 95%/5% and a flow rate of 2 L/min. The perfusate was supplemented with continuous infusion of epoprostenol (flolan) (8 ml/h) and aprotinin (10 mL/h). The dialysate was composed of a commercial concentrated hemodialysis solution (Solution A, D12188M, 45X, K1, Ca 1.00, Baxter), sodium bicarbonate, sodium pyruvate, double reverse osmosis water, and potassium bicarbonate and infused at 1 L/h throughout the entire perfusion. To ensure optimal perfusion, the arterial pressure was carefully regulated to remain between 20 to 25 mmHg. The pancreas graft was placed in a custom-made transparent box, which is equipped with a built-in external heater and thermometer, allowing for continuous monitoring of the temperature.

Following execution of the preservation techniques (SCS for the control group and NEVP for the study group), the grafts in both groups were transplanted. Sedation, intubation, and central line placement were carried out. Additionally, an arterial line was placed in the carotid artery for invasive arterial pressure monitoring. For the recipient, the fentanyl infusion was increased to 5 μg/kg and extended release buprenorphine injection along with sedation drugs at 0.24 ml/ml.

After these procedures and baseline sampling, a midline incision was performed, the distal IVC and aorta were dissected and prepared for anastomosis. A pancreatectomy was then conducted while preserving duodenum vasculature and leaving the spleen in situ.

In the control group, the graft was maintained on ice until the moment of transplantation. In contrast, for the study group, the graft underwent 2 hours of SCS, 3 hours of perfusion, followed by a biopsy and a flush with 300 ml of UW solution, and was stored in cold until the time of transplantation. During transplantation, the vein and the artery of the graft were anastomosed in an end-to-side manner using 6-0 polypropylene sutures. The graft was then reperfused, hemostasis was performed, and a side-to-side anastomosis of the duodenum and small bowel was performed using 4-0 polyglyconate suture.

The recipient animals in both groups were followed for 3 days. Cyclosporine (Neoral, oral solution, 100 mg/ml) was initiated at 15 mg per kg per day, divided in 2 doses as soon as the animals were able to tolerate oral intake, typically within 12 to 24 hours post-procedure.

### Samples and Biopsies

Baseline amylase, lipase, lactate dehydrogenase (LDH) and blood gas analysis (BGA) were taken on both the donor and the recipient. Blood samples were collected at 60, 120, and 180 min after reperfusion and daily until sacrifice.

The endocrine function of the transplanted graft was evaluated by measuring glucose levels at various time points throughout the study. Additionally, on postoperative day 3 and prior to sacrifice, a glucose tolerance test was conducted. During this test, a bolus of 50 ml of 50% dextrose was administered via the central line, and blood samples were collected at specific timepoints.

The recipient's plasma samples stored at −80° C. were used to assess C-peptide levels, using an ELISA kit (Mercodia Porcine C-peptide ELISA). Samples were analyzed at several timepoints including baseline, POD1, POD3 (before the start of the glucose test) and at 2, 10, 30, 60 and 120 minutes after the glucose bolus.

Perfusate samples were collected at hourly intervals to assess the levels of amylase and lipase. Additionally, arterial, and venous samples were collected hourly for blood gas analysis. After sample collection, the remaining perfusate was subjected to centrifugation, and the plasma fraction was preserved at −80° C. for subsequent analysis.

An 8-Hydroxy-2-deoxyguanosine ELISA kit (OxiSelect Oxidative DNA Damage ELISA kit, Cell Biolabs, Inc.) was used for oxidative stress assessment on frozen samples from recipient plasma at three distinct time points: at baseline, on POD1, and on POD3.

All tissue samples were fixed in 10% neutral buffered formalin for 48 hours, transferred to 70% alcohol and sent out for paraffin embedding, H&E, insulin, glucagon, TUNEL and 8OHdg staining. A specialized pathologist analyzed the slides and used a previously developed semi-quantitative scale to score fat and parenchyma necrosis, edema, and hemorrhage (0—no changes, 1—mild changes, 2—moderate changes, 3—severe changes).

TUNEL stain slides were used as a marker of apoptosis and subjected to analysis using QuPath software to estimate the percentage of positive cells. Each slide was analyzed individually using the following steps:
1. The image was loaded into the software and zoomed to a scale bar of 100 μm.
2. An approximate rectangular area of 1500 mm² was selected for analysis.
3. Vector strain detection was optimized automatically, and the rest of the parameters were fine-tuned manually until satisfactory cell detection was achieved.
4. Once this first area was optimized, same parameters were used to analyze three random areas of approximately the same size on the same slide.
5. After ensuring satisfactory optimization, the entire slide was analyzed for positive cell detection.
6. A thorough check of the whole slide was performed to confirm the accuracy of the selection process.
7. If any areas were inaccurately selected, they were manually excluded from the analysis.
8. Each slide was independently read three times with the same final parameters to ensure the accuracy of the percentage of positive cells obtained.

### Analysis

Descriptive statistics (mean and standard deviation (SD), median interquartile range (IQR)) were used to summarize donor and recipients' characteristics as well as clinical outcomes. Categorical variables were compared between groups using either a chi-square test or Fisher's exact test. Groups were compared using 2-way ANOVA test. A p-value of less than 0.05 was considered statistically significant. Statistical analysis was performed using GraphPad prism 10 software. QuPath open software for image analysis version 0.4.3 was used to analyze histopathology slides.

### Results

As shown in Table 3, no significant differences were observed in baseline characteristics between donors and recipients for both groups. The mean weight of the donors in the SCS was 42.7±1.5 kg, and in the NEVPP group, 39.7±1.9 kg (p=0.10). Similarly, the mean recipient weight was 42.1±2 kg in the SCS group and 39.7±2.1 kg in the NEVPP group (p 0.23). The mean donor amylase was 1336±167.5 U/L, and 1734±613 U/L for the SCS vs NEVPP, respectively (p 0.13). The mean donor recipient amylase was 1327±324 U/L for the SCS group and 1697±115 U/L for the NEVPP group (p 0.13).

TABLE 3
Donor and recipient baseline characteristics (Example 1)

| | SCS (Control Group) | NEVP (Study Group) | P |
|---|---|---|---|
| Donor Weight | 42.7 ± 1.5 | 39.7 ± 1.9 | 0.10 |
| (kg) | | | |
| Recipient Weight | 42.1 ± 2 | 39.7 ± 2.1 | 0.23 |
| (kg) | | | |
| Donor BL | 1336 ± 167.5 | 1734 ± 613.4 | 0.33 |
| amylase (U/L) | | | |
| Recipient BL | 1327 ± 324 | 1697 ± 115 | 0.13 |
| amylase (U/L) | | | |
| Donor BL lipase | 4.6 ± 1.1 | 4 | 0.37 |
| (U/L) | | | |
| Recipient BL | 4 | 4 | 1 |
| lipase (U/L) | | | |
| Donor BL LDH | 669 ± 182 | 603 ± 12 | 0.56 |
| (U/L) | | | |
| Recipient BL | 687 ± 212 | 771 ± 218 | 0.65 |
| LDH (U/L) | | | |

Throughout the entire perfusion, the arterial pressure remained stable, with a mean value of 25.16±1.52 mmHg. The mean arterial flow was 110.83±14.43 ml/min. The mean intravascular resistance was 0.12±0.02 mmHg/ml/min per 100 g.

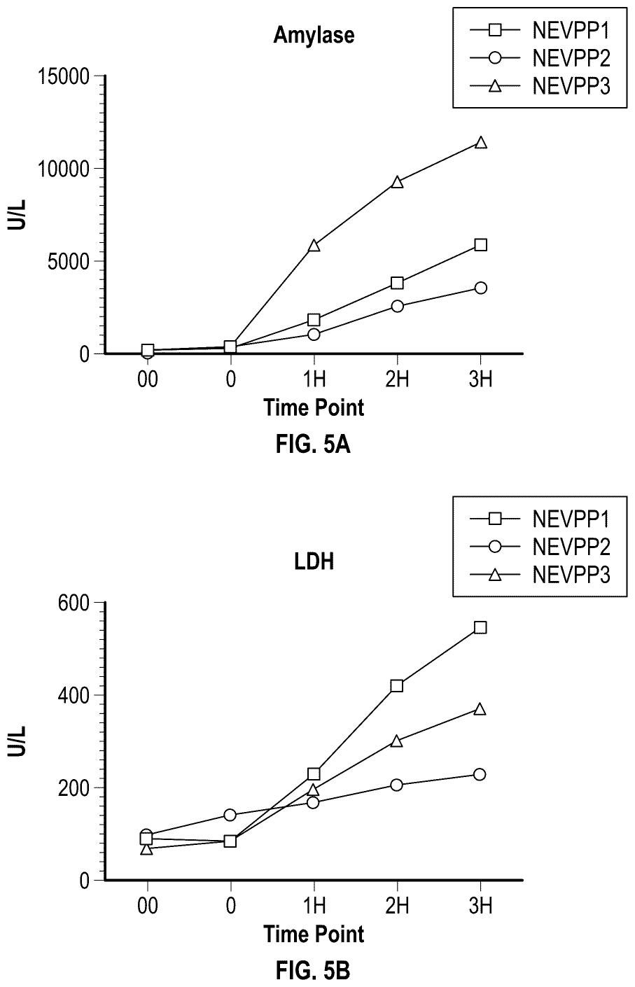

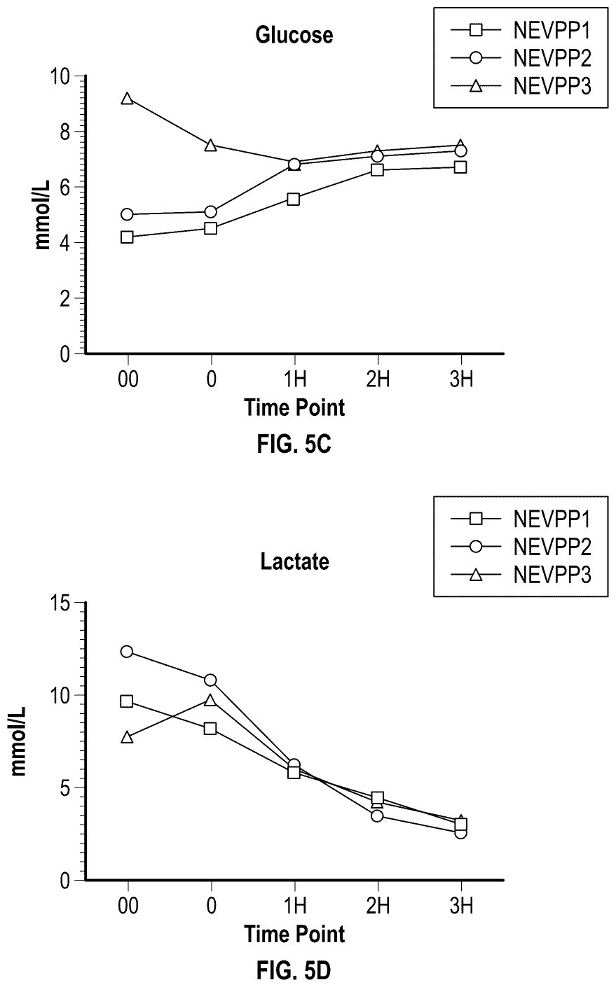

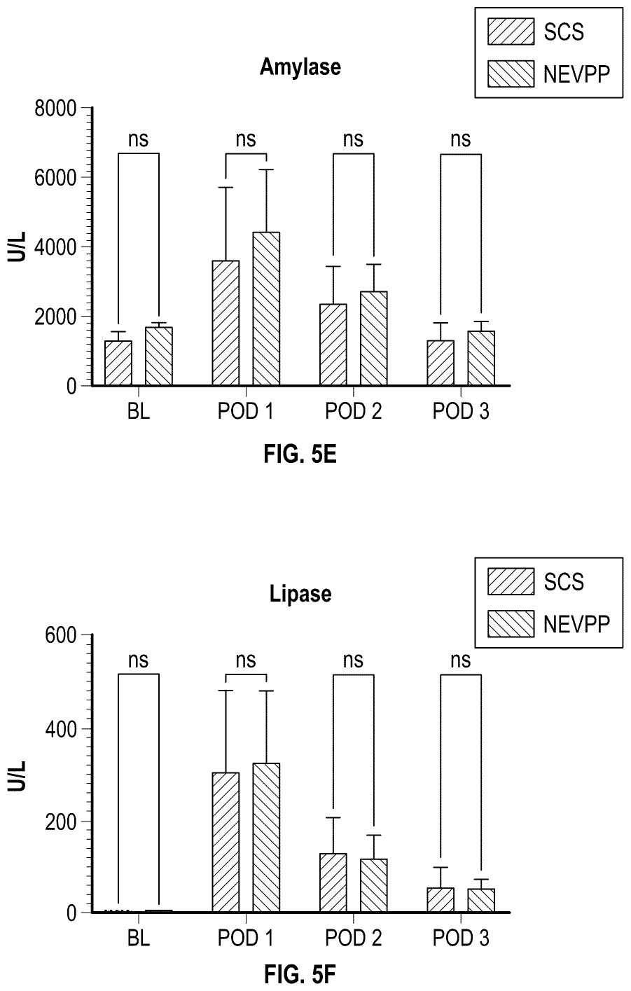

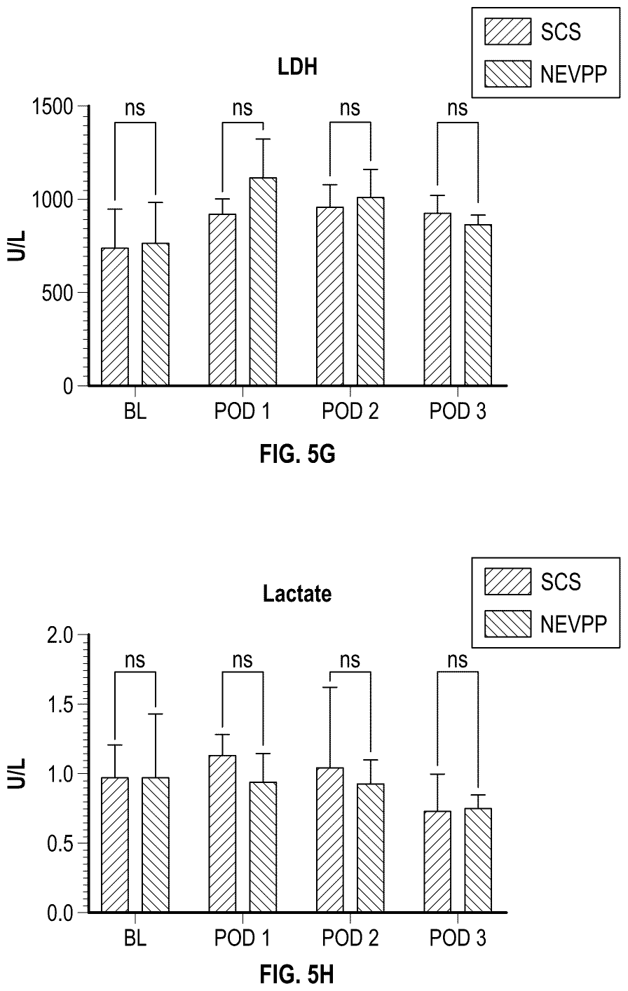

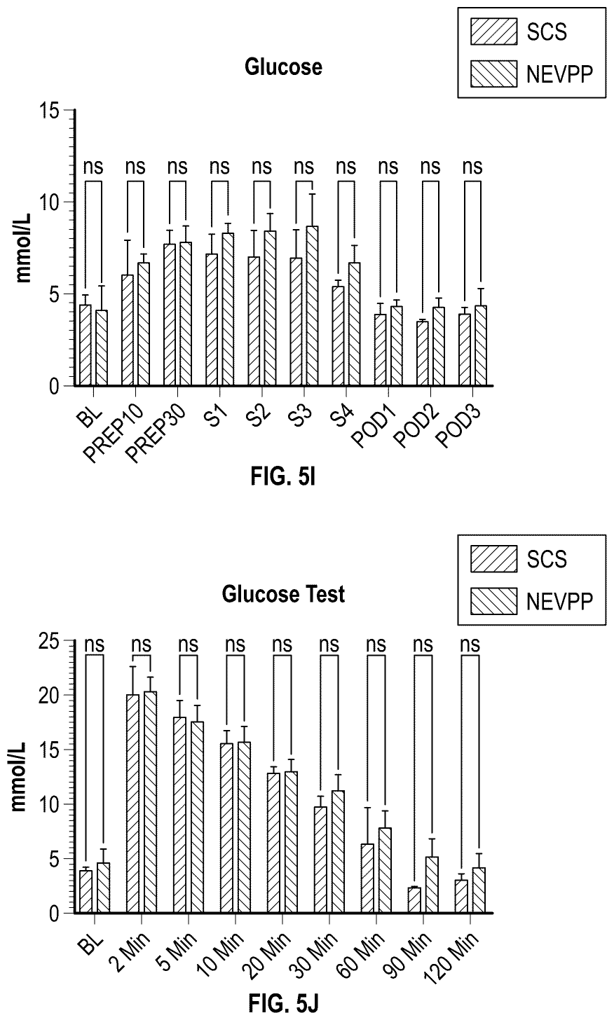

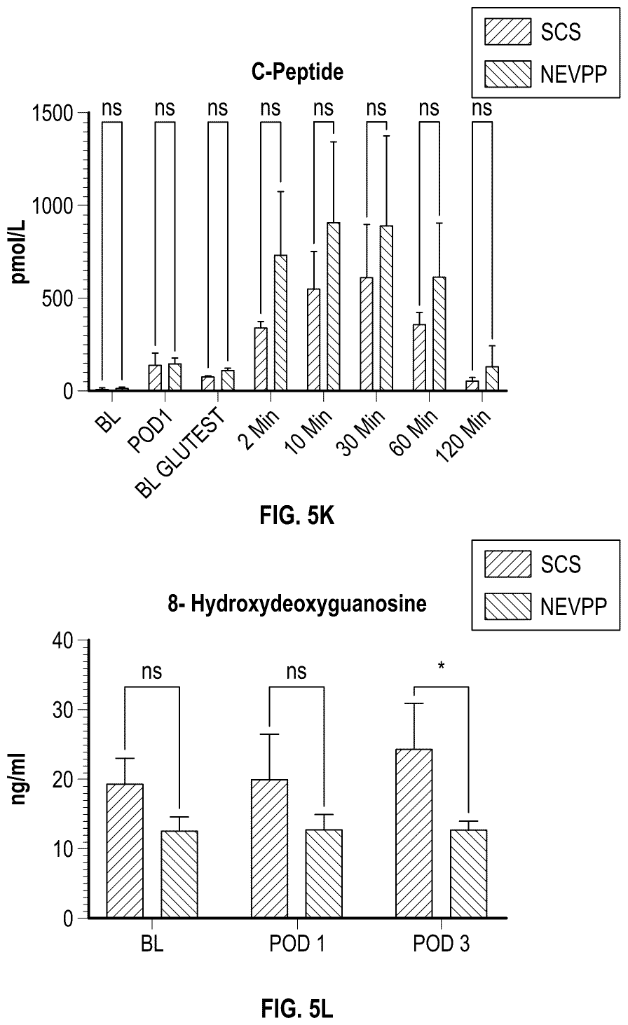

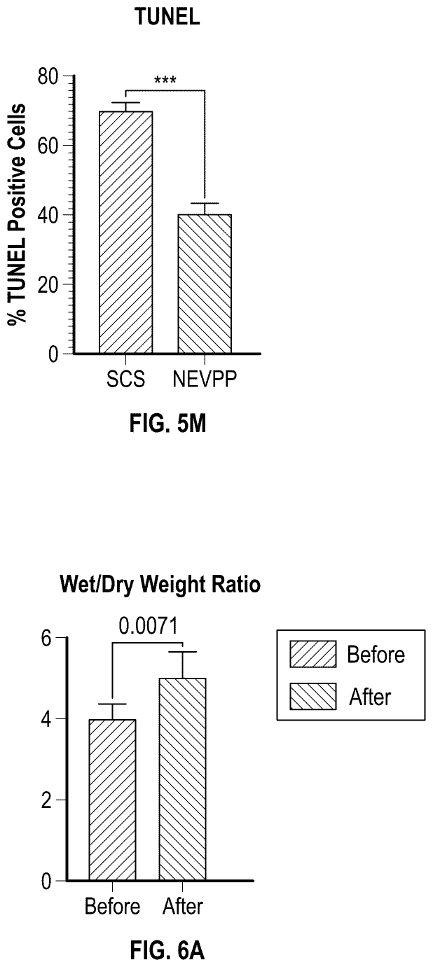

A marked elevation in amylase levels was observed, with a median value of 1829 U/L (IQR=5529) (FIG. 5A). The measure of lipase levels during the perfusion was hampered by the early saturation of the assay's range, precluding any meaningful analysis. Lactate Dehydrogenase (LDH) levels also increased during the perfusion, with a median value of 197 U/L (IQR=285.5) (FIG. 5B)

Levels of pH, pCO2, pO2 and HCO3 were stable throughout the perfusion. Glucose and lactate levels stabilized by the end of the three-hour perfusion period. Plots of glucose levels and lactate levels during the perfusion are shown in FIGS. SC and SD), respectively.

Table 4 presents the weight of the pancreas grafts in both groups. The observed changes in weight in the NEVPP group ranged from 10 g to 109 g, reflecting a percent change of 6.5% to 55%.

TABLE 4
Graft weight before and after preservation (Example 1)

| | SCS, | SCS, | SCS, | NEVP, | NEVP, | NEVP, |
|---|---|---|---|---|---|---|
| | Case 1 | Case 2 | Case 3 | Case 1 | Case 2 | Case 3 |
| Graft weight | 136 | 129 | 183 | 154 | 184 | 198 |
| before | | | | | | |
| preservation | | | | | | |
| (grams) | | | | | | |
| Graft weight | 136 | 129 | 183 | 164 | 245 | 307 |
| after | | | | | | |
| preservation | | | | | | |
| (grams) | | | | | | |
| Change of | N/A | N/A | N/A | 10 | 61 | 109 |
| weight (grams) | | | | | | |
| Weight change | N/A | N/A | N/A | 6.5 | 33.1 | 55 |
| percentage | | | | | | |

The mean values of amylase and lipase in the recipients showed no significant differences between the two groups at baseline or during the 3-day postoperative follow up period, as shown in FIGS. 5E and SF. LDH levels, a marker of cell death, did not show any significant difference between the SCS and the NEVPP group (see FIG. 5G). Lactate levels, an indirect measure of perfusion, were not significantly different between the groups at any time point (FIG. 5H)

The glucose levels measured at various time points before, during, and after the transplant procedure did not reveal any significant difference between groups (FIG. 5I). This includes the glucose test performed on POD3 (FIG. 5J). The results also indicate no significant difference in C-peptide levels between the SCS and the NEVP groups at different time points during the follow-up period and glucose tolerance test, as shown in FIG. 5J.

No statistical difference was noted at baseline and on POD1. However, 8-hydroxyguanosine was significantly lower on POD 3 for the NEVP group (12.66±0.11 ng/ml vs 21.22±2.74 ng/ml, p=0.0012) (FIG. 5L).

Minimal tissue injury was observed in the SCS group and in the NEVP group after 5 hours of cold storage or 2 hours of cold storage and 3 hours of perfusion, respectively, and at 1 hour after reperfusion, presenting only mild to moderate changes in both groups. However, upon sacrifice, the NEVP group had an overall better microscopic appearance compared to the SCS group, evidenced by milder fat necrosis, parenchyma necrosis, and hemorrhage.

Islets morphology was preserved in both groups as demonstrated by using insulin and glucagon staining. Apoptosis, as demonstrated by TUNEL staining, was significantly lower in the NEVP group compared to the SCS group (p=0.0002) (FIG. 5M).

### Example 2—NEVP of Human Pancreas (1)

In this example, six human pancreases were perfused using the provided systems and methods. All six pancreases were successfully perfused for 4 h, with minimal edema. The mean glucose and lactate levels decreased throughout perfusion and insulin levels increased. All six grafts were metabolically active during perfusion and histopathology showed minimal tissue injury and no edema. The results of the experiment discussed in this example suggest that human normothermic ex-vivo perfusion of the pancreas is feasible and safe and has the potential to expand the donor pool.

### Summary of Experiment

Six discarded human pancreas allografts were recovered from multiorgan donors. The recovered pancreas allografts were prepared for NEVP utilizing a back-table preparation typical for human pancreas implantation. Each organ was inspected for any significant damage that would affect the perfusion. The spleen was removed by ligating the splenic artery and vein close to the hilum of the spleen. Iliac vessels were recovered from the donor and any small branches were suture ligated. Arterial reconstruction was performed using the donor iliac artery as a “Y graft.” The external iliac artery and internal iliac artery were anastomosed to the splenic artery and the superior mesenteric artery with a 6-0 polypropylene suture, respectively. The common iliac artery was then used for cannulation. An iliac vein was used as an extension graft by anastomosing the iliac vein to the graft portal vein in an end-to-end fashion using 6-0 polypropylene suture. The artery and vein were cannulated with ¼″×⅜″ reducers. The bowel was shortened if necessary and a Malecot catheter was inserted into the distal end to collect duodenal and pancreatic exocrine output during perfusion The pancreas was weighed after completion of the back table and then flushed with 200 mL of 5% albumin before initiating NEVPP.

The pancreas allografts were perfused for 4 h using the provided systems and methods. During perfusion, the perfusate traveled from the venous reservoir with the help of a centrifugal pump into an oxygenator. Following oxygenation, a first part of the perfusate was circulated through a dialysis filter and then back to the reservoir, and a second part of the perfusate was passed through an arterial bubble filter and then into the pancreas graft. The venous outflow was transported back into the venous reservoir.

The first four grafts were perfused with an O2/CO2 concentration of 95/5%, while the last two grafts were perfused with a concentration of 91/9%. The perfusate's composition is shown in Table 5.

TABLE 5
Perfusate composition (Example 2)

| Ingredient | Amount | |
|---|---|---|
| STEEN solution | 215 | mL |
| PRBC | 400 | mL |
| NaHCO₃ (8.4%) | 10 | mL |
| Heparin (10,000 IU/mL) | 1.3 | mL |

| | |
|---|---|
| Aprotinin | 30 mg dissolved in 60 mL of ringer's |
| | lactate. 30 mL (15 mg) directly poured into |
| | venous reservoir; remainder infused at 10 |
| | mL/h |
| Epoprostenol | 0.5 mg dissolved in 250 mL of ringer's |
| | lactate and infused at 8 mL/h |

Dialysate was infused at a rate of 1 L/h. The dialysate consisted of 22 mL of 45× concentrated hemodialysis solution (Baxter Corporation), 27 mL of 8.4% sodium bicarbonate, 3 mL of 8.4% potassium bicarbonate, 275 mg of sodium pyruvate, and 1.5 g of NaCl. The volume was then brought up to a liter with double reverse osmosis water.

The total perfusion time was 4 h. During the perfusion, arterial pressure and flow were measured and recorded every hour. Blood gas analysis from the perfusate was used to record acid-base and electrolyte balance and samples were taken every hour for storage. Duodenal output was measured every hour and recorded if present.

A core biopsy (Bard, Monopty disposable core biopsy instrument, 14 g×16 cm, Georgia, USA) was taken from the tail before the start of the perfusion and at 1 h of perfusion. At the end of the perfusion, four wedge biopsies were taken from the head, body, tail, and duodenum. These biopsies were fixed in formalin, snap frozen, and stored in RNA later (Stabilization Solution, Invitrogen, Thermo Fisher Scientific). All the formalin samples (10% neutral buffered formalin) were stored for 48 h and then transferred to 70% alcohol. The samples were then sent for paraffin block embedding and hematoxylin and eosin (H&E) staining. A semi-quantitative scale was used to score fat and parenchyma necrosis (0—no changes, 1—mild changes, 2—moderate changes, 3—severe changes).

For the assessment of islet cells, additional insulin staining was performed and reported as number of islet cells at a 4× magnification. For the assessment of apoptosis, a TUNEL assay was performed on the end of perfusion samples and reported as negative, <30%, 30%-60% or >60%. For the assessment of vascularity of the grafts, a CD31 staining was performed. Interstitial edema was assessed on histopathology and classified as none, mild, moderate, or severe.

Samples of the perfusate were stored at −80° C. These samples were thawed and used to measure thiobarbituric acid reactive substances (TBARS) using a commercial assay kit (OxiSelect TBARS Assay Kit, Cell Biolabs, Inc.).

### Analysis

Continuous data were represented as mean and standard deviation and plotted versus time for each case. GraphPad Prism Software 9 was used for analysis and graphs. For each case, the following variables were collected: age, cause of death (COD), type of donor (neurological death donor (NDD) or donor after cardiac death (DCD)), gender, height, BMI, cold ischemia time (CIT), blood type, and reason for discard.

### Results

Characteristics of the donors and cold ischemia times are shown in Table 6. Half of the donors were male. Of the six included cases, only one graft came from a DCD donor, with a warm ischemia of 17 min. The mean age was 44.16±13.79 years. The cause of death was anoxia in 2 donors, cardiac arrest in 2 donors, CVA/stroke in 1 donor, and head trauma in 1 donor. The mean cold ischemia time was 372.50±137.69 min with a range of 173-547 min. The mean height was 172.50±14.42 cm, the mean weight was 78.46±25.70 kg, and the mean BMI was 25.71±5.81. The reason for discard was fatty infiltration in 2 grafts, older donor in 2 cases and high BMI in one case. Four out of the six donors presented a cardiac arrest event that required CPR and five out of six required vasopressors.

TABLE 6
Donor characteristics (Example 2)

| | Case 1 | Case 2 | Case 3 | Case 4 | Case 5 | Case 6 |
|---|---|---|---|---|---|---|
| Age | 44.16 ± 13.79 (26-62) | | | | | |
| (mean ± SD) | | | | | | |
| (Range) | | | | | | |
| Height (cm) | 172.50 ± 14.42 (151-183) | | | | | |
| (mean ± SD) | | | | | | |
| (Range) | | | | | | |
| Weight (kg) | 78.46 ± (25.70) (38.8-114.8) | | | | | |
| (mean ± SD) | | | | | | |
| (Range) | | | | | | |
| BMI (kg/m²) | 25.71 ± 5.81 (17-34.3) | | | | | |
| CIT (min) | 372.50 ± 137.69 (173-547) | | | | | |
| (mean ± SD) | | | | | | |
| (Range) | | | | | | |
| Gender | Male | Male | Male | Female | Female | Female |
| Type of | NDD | NDD | NDD | NDD | DCD | NDD |
| Donor | | | | | | |
| Cause of | CVA/Stroke | Anoxia | Anoxia | Cardiac | Cardiac | Head |
| Death | | | | arrest | arrest | trauma |
| Blood Type | O positive | A positive | B positive | A positive | A positive | B positive |
| WIT (min) | N/A | N/A | N/A | N/A | 17 | N/A |
| Reason for | BMI | Fatty | Fatty | Fatty | Age | Age |
| Discard | | infiltration | infiltration | infiltration | | |
| | | of the graft | of the graft | of the graft | | |

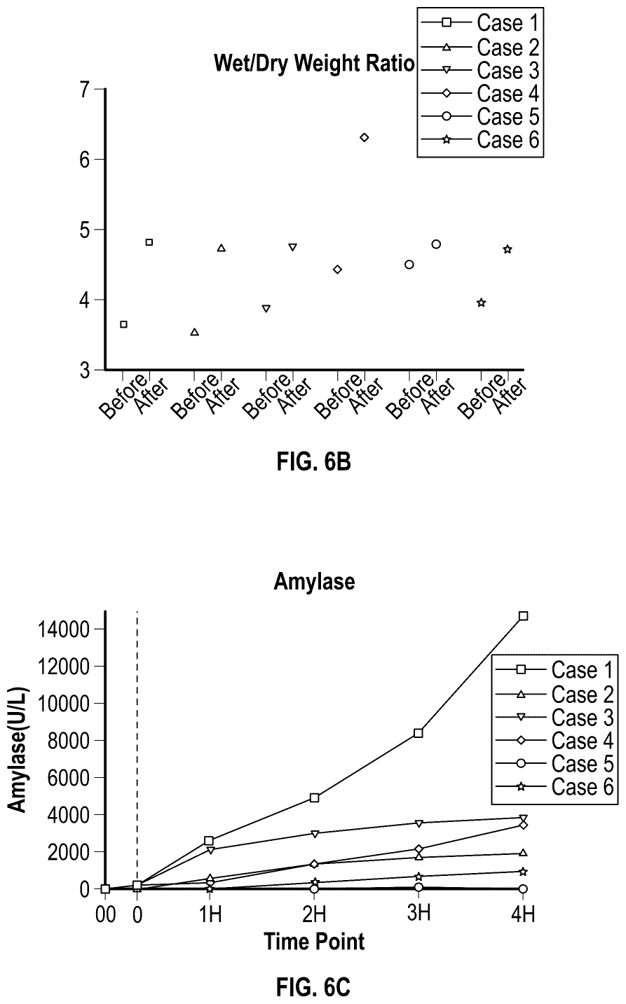

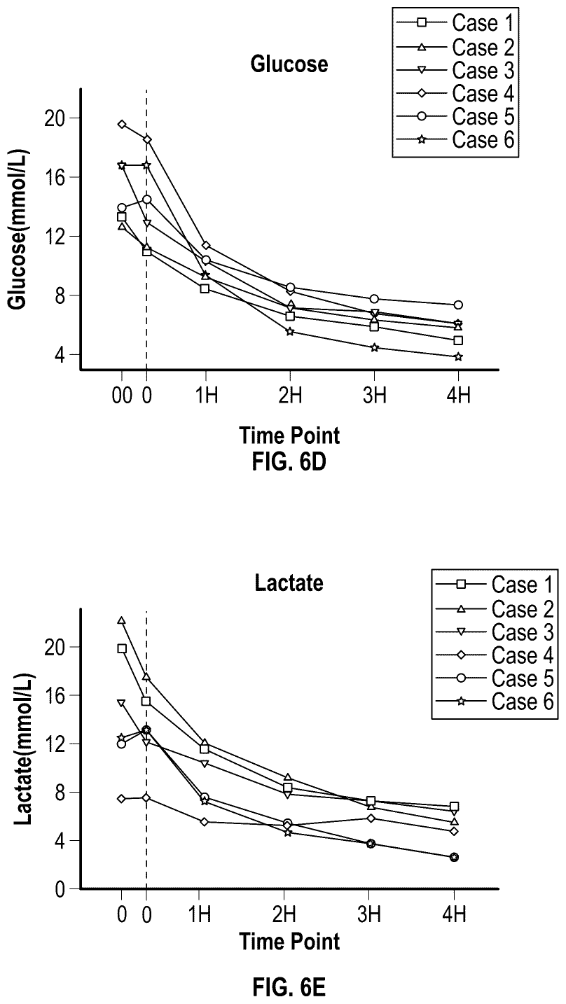

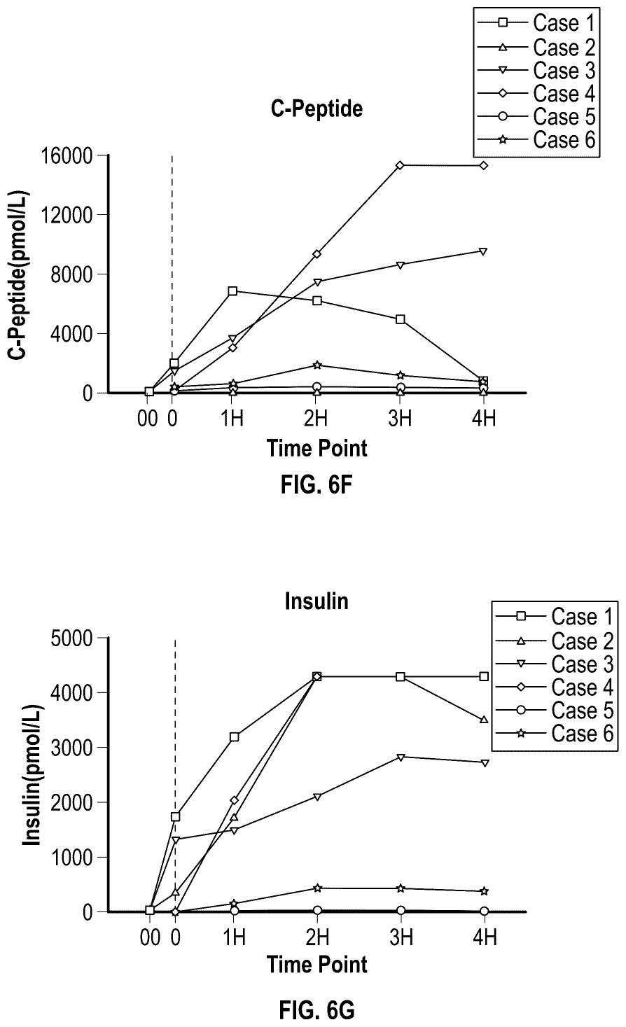

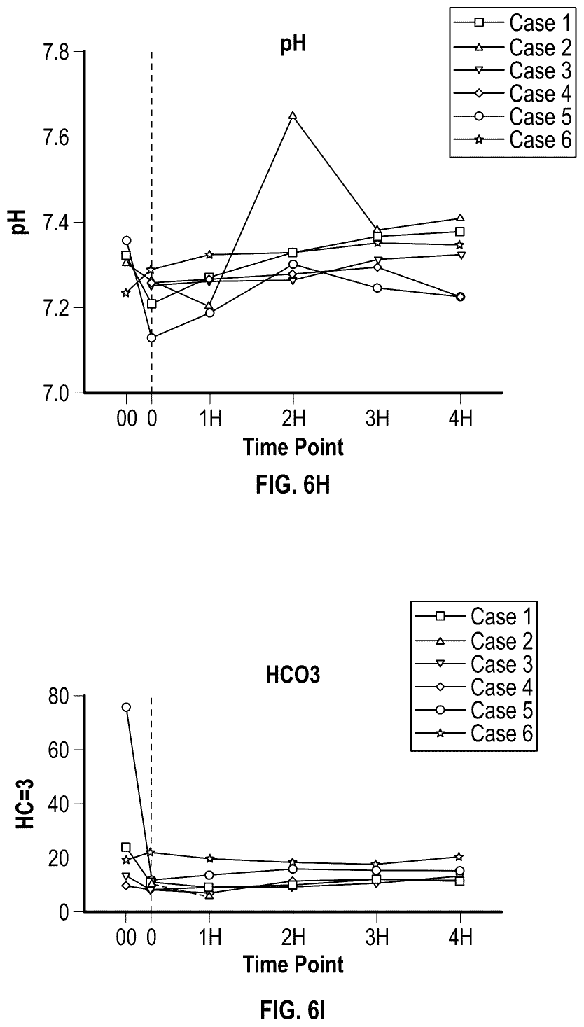

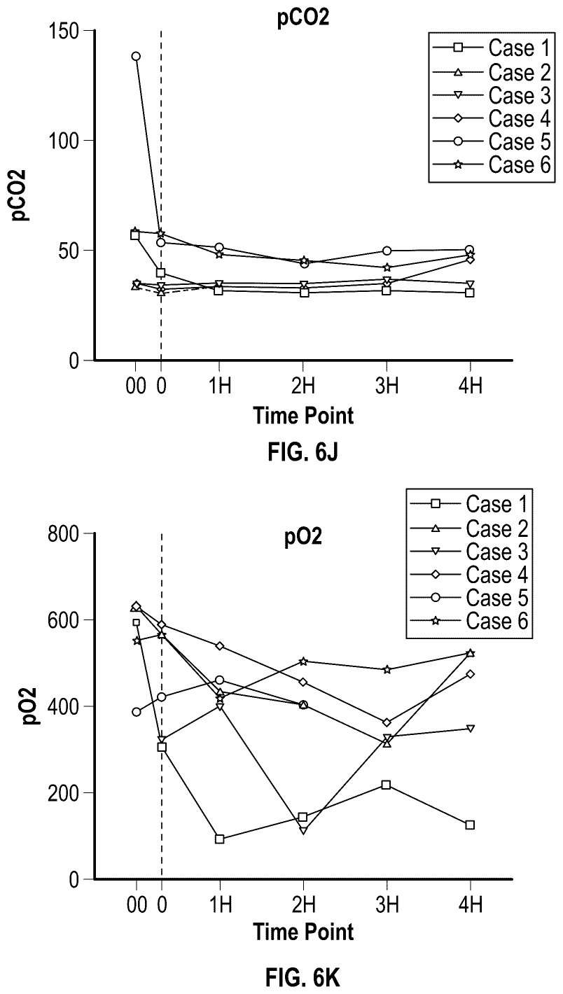

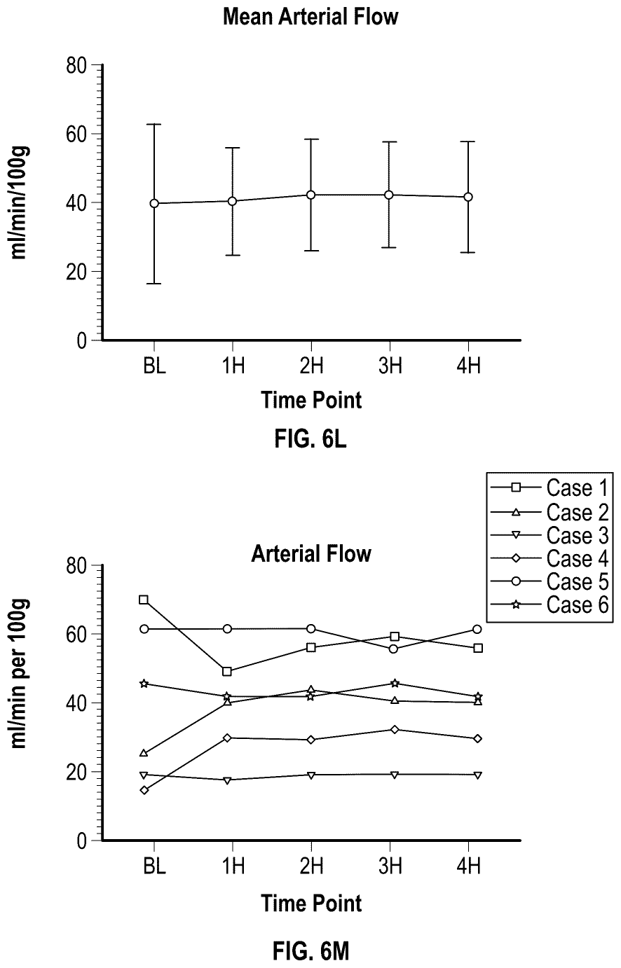

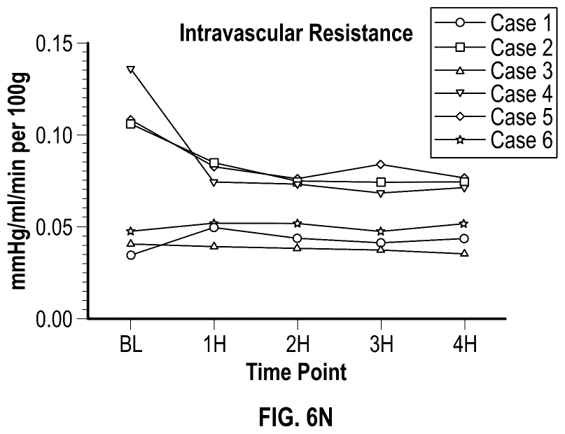

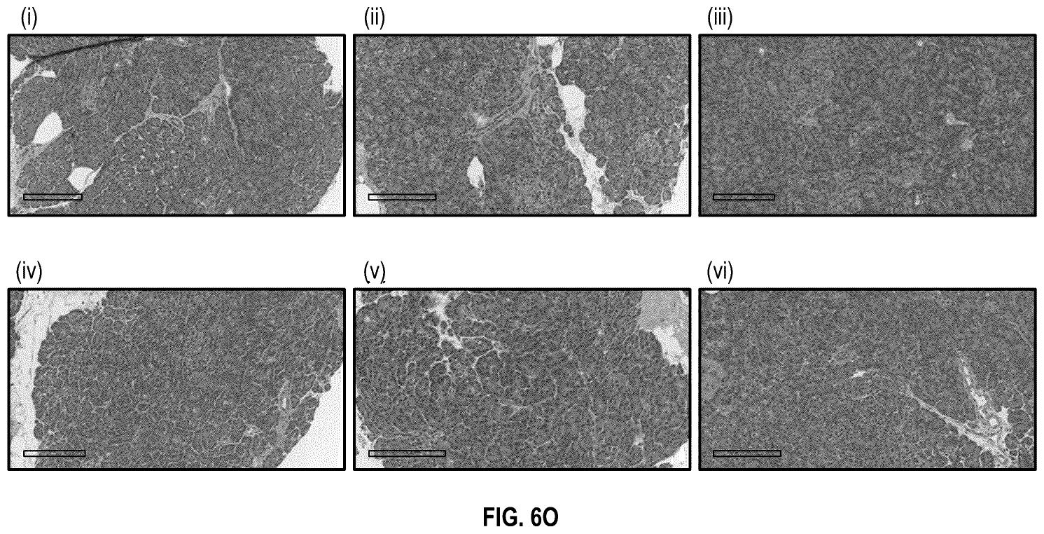

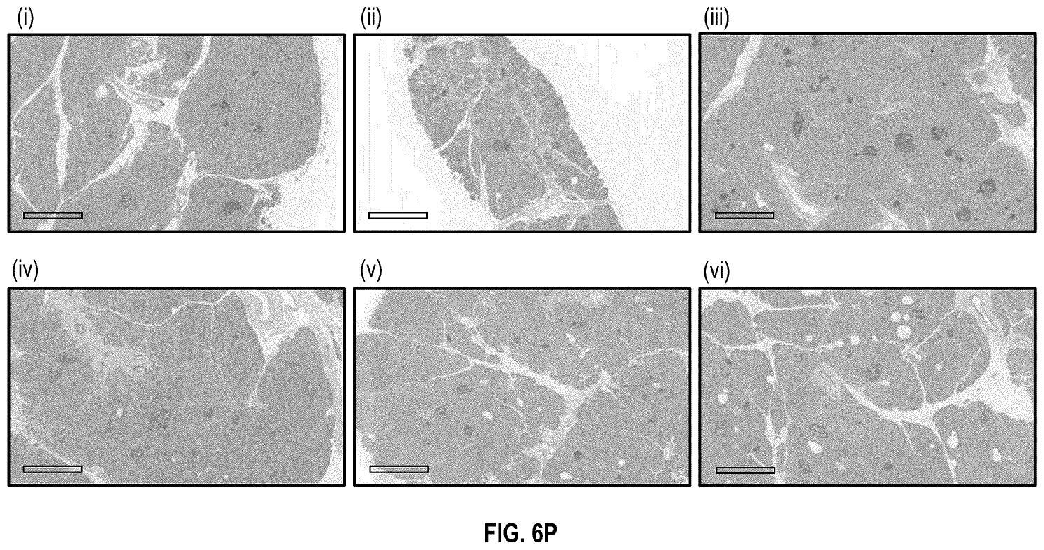

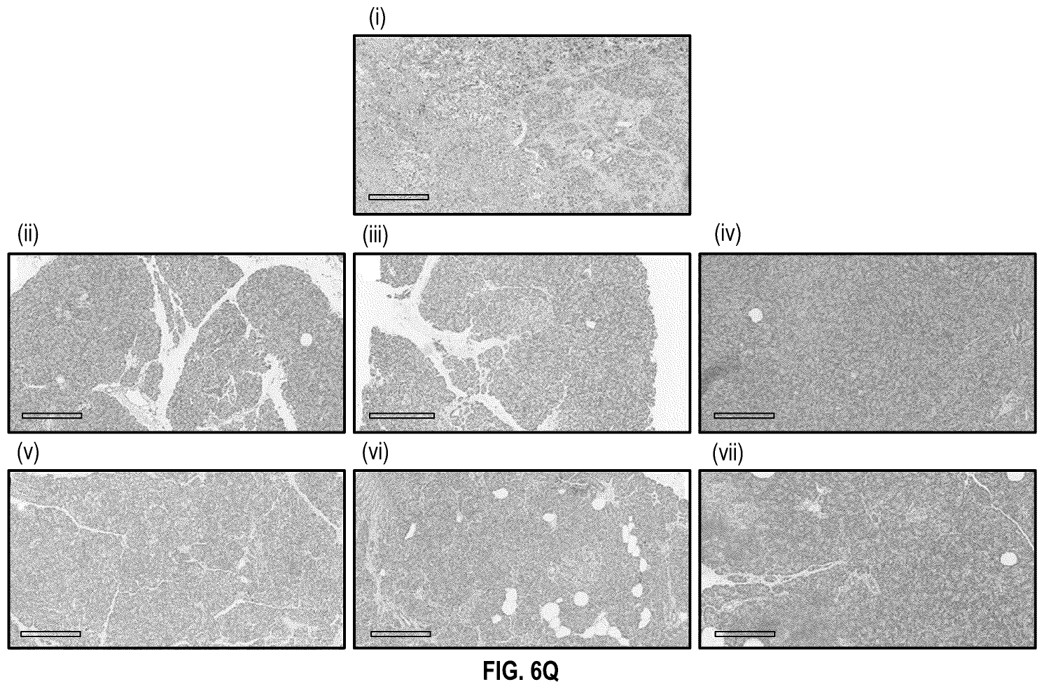

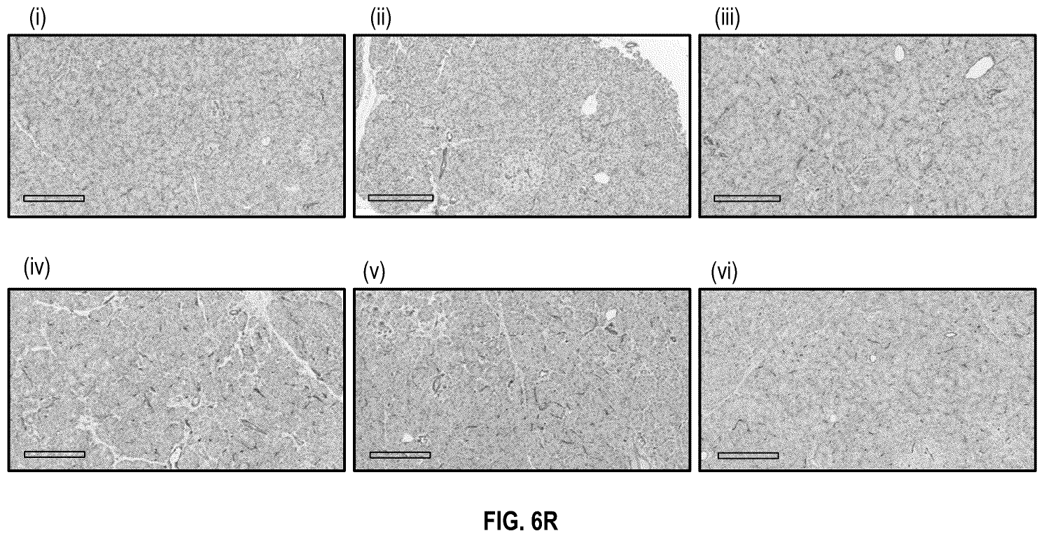

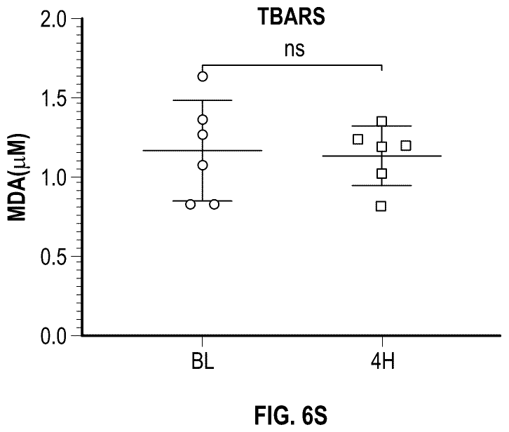

All the grafts (pancreas and duodenum) perfused evenly during the 4 h of perfusion, without any macroscopic evidence of poor circulation. The mean wet/dry weight ratio was 3.99±0.39 before perfusion and 5.02±0.63 after perfusion (p=0.007), as shown in FIG. 6A. The change in ratio ranged from 6% to 42%. Individual wet/dry ratio values for each case are provided in FIG. 6B.

Amylase levels increased during the 4 h of perfusion (median: 796.5 U/L, IQR: 2430.75) (see FIG. 6C). No significant difference was noted between amylase of the CO2 5% group vs. CO2 9% group. Glucose and lactate levels decreased during the 4 h of perfusion (median: 7.55 mmol/L, IQR: 4.025 mmol and median: 7.18 mmol/L, IQR: 4.59 mmol/L, respectively) (FIGS. 6D-6E). C-peptide levels (median: 1,084.5 pmol/L, IQR: 5559.75 pmol/L) during perfusion were more variable between cases (FIG. 6F), and insulin levels increased in all the cases during the perfusion, except for case 5 (FIG. 6G). Levels of pH, HCO3 and, pCO2 were consistent throughout the perfusion (FIG. 6H-FIG. 6J). pO2 levels were more variable during the perfusion but always exceeded 100 mmHg (FIG. 6K).

The arterial flow was stable throughout the 4 h of perfusion with a mean of 40.9±16.19 mL/min/100 g (FIGS. 6L-6M). Intravascular resistance was slightly higher for cases 2 (0.082±0.013 mmHg/ml/min per 100 g), 4 (0.083±0.028 mmHg/ml/min per 100 g), and 5 (0.084±0.002 mmHg/ml/min per 100 g) as compared to cases 1 (0.042±0.005 mmHg/ml/min per 100 g), 3 (0.038±0.002 mmHg/ml/min per 100 g), and 6 (0.049±0.002 mmHg/ml/min per 100 g) with a significant difference between means (p<0.001) (FIG. 6N). The CO2 5% group appeared to have a lower mean intravascular resistance than the CO2 9% group.

Minimal tissue injury was noted in both the CO2 5% and CO2 9% groups and grafts from both groups were morphologically normal (FIG. 6O). Overall, the parenchyma was largely intact, with very mild focal necrosis, normal ducts, and mild hemorrhage/congestion. The duodenum showed mild to moderate erosive changes and mild autolysis. Islet cells were present in all the cases (FIG. 6P). No edema was observed in any of the grafts and TUNEL assay was negative for all the cases except for case 1 which presented less than 30% (approximately 5%) (FIG. 6Q). All grafts were vascularized at the end of the perfusion as seen in the pancreatic tissue stained with CD31, with no evidence of thrombosis (FIG. 6R).

TBARS were measured from the perfusate at baseline and at the end of the perfusion. No significant difference was noted between samples at baseline and at the end of the perfusion (p=0.84), as shown in FIG. 6S.

### Example 3—NEVP of Human Pancreas (2)

In this example, two human pancreas grafts that were initially discarded and donated for research were obtained and subjected to NEVP according to the provided techniques. Both grafts were obtained from male non-heart-beating donors (NDD). Case 1 involved a 26-year-old donor with a BMI of 22.7 and a cold ischemia of 547 minutes. Case 2 involved a 55-year-old donor with a BMI of 19 and a cold ischemia time of 383 minutes. The grafts were initially discarded due to fatty infiltration in Case 1 and the donor's age in Case 2. The grafts underwent back-table preparation with additional cannulation of the Y graft and portal vein as well as insertion of a Malecot catheter on the distal side of the duodenum. The grafts were then placed on in the NEVP system (see, e.g., system 100 shown in FIG. 1) and perfused for a period of four hours.

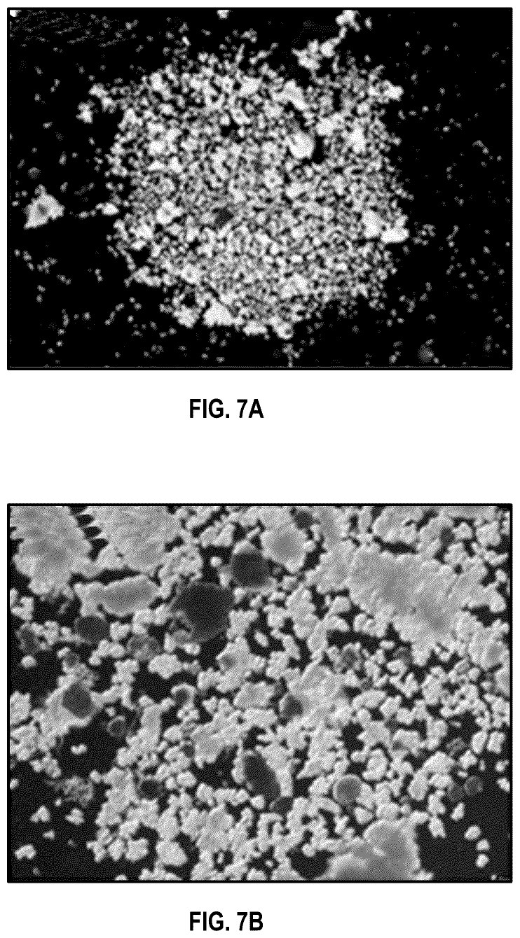

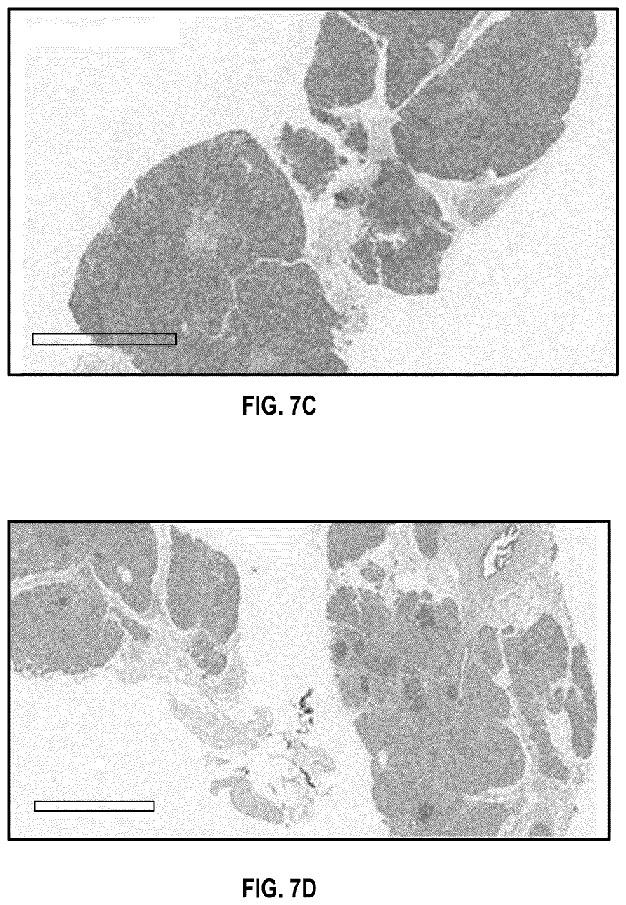

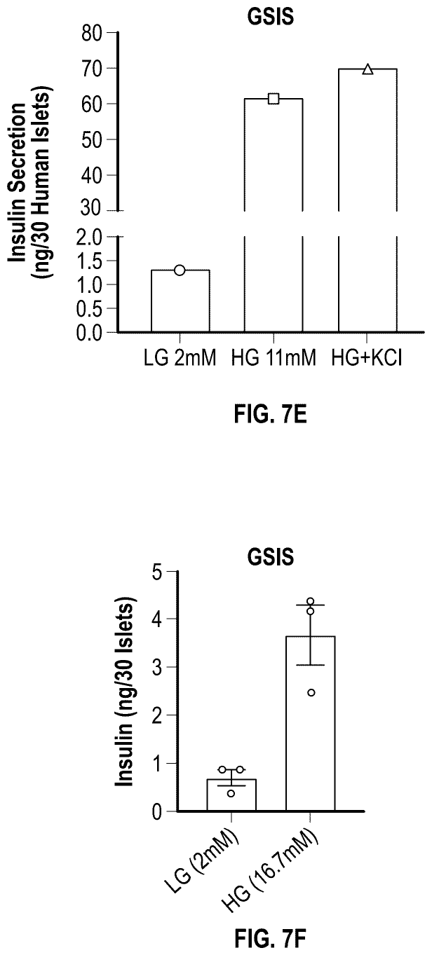

Both human pancreas grafts were successfully perfused for the established 4 h period, with subsequent islet isolation. In case 2, the pre-purification islet yield was 626,204 and the post-purification islet yield was 220,801. Pre- and post-purification islets are shown in FIGS. 7A and 7B.

The morphological integrity of the pancreas was assessed through H&E staining (FIG. 7C), while integrity the islets was evaluated by insulin staining (FIG. 7D). A glucose-stimulated insulin secretion test was performed on both cases (FIGS. 7E-7F). The results indicated that the isolated islets from both grafts responded appropriately, secreting insulin at high glucose concentrations. Notably, case 1 demonstrated an above average insulin response, with a fold increase of 46 compared to basal secretion.

### Example 4—NEVP of Porcine Pancreas (2)

In this example, porcine pancreas grafts were subjected to prolonged cold ischemia (≥21 hours) to determine if the grafts could be optimized using the provided systems and methods. The study population consisted of 35-40 kg male Yorkshire pigs in an allo-transplantation model with a 3-day survival plan for the recipient. Control grafts were subjected to cold storage (CS) in University of Wisconsin solution for 21-24 hrs (n=6), while the study group received additional 3 hrs NEVP after CS of 21 hrs (n=5).

The 3-day survival was 60% in NEVP arm vs 0% in control arm (p=0.008; Log rank). Graft parenchyma was 60-70% preserved in the NEVP arm at necropsy on gross appearance. In addition, the islet function was well preserved, and both the pancreas (including the islets) and the duodenal morphology were maintained histologically. The IV glucose tolerance test on day of sacrifice was in normoglycemic range for 80% cases in NEVP arm. These results suggest that the disclosed techniques can be used to rescue and reanimate grafts for transplantation.

### Summary of Experiment

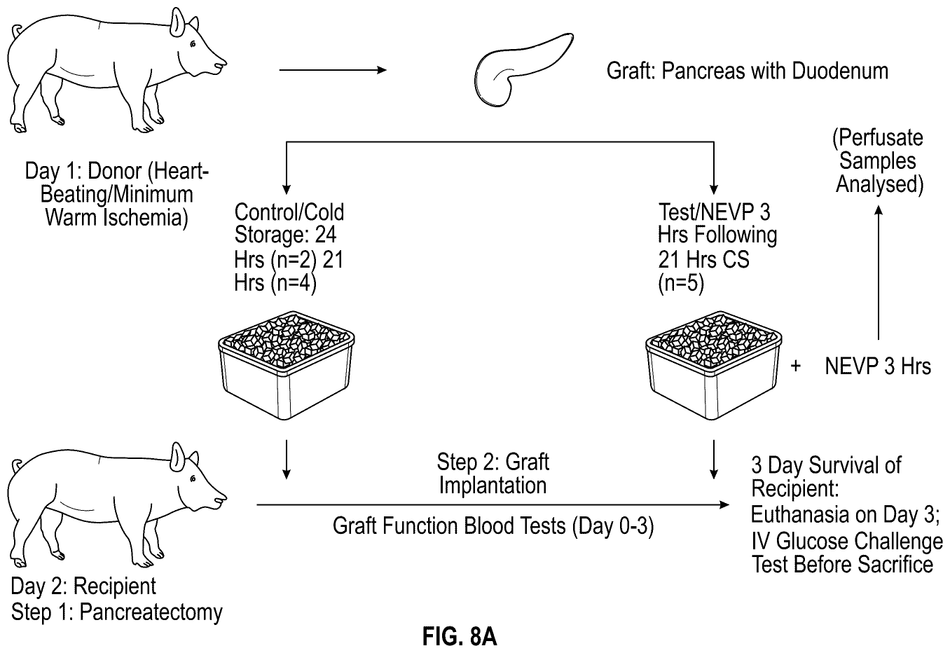

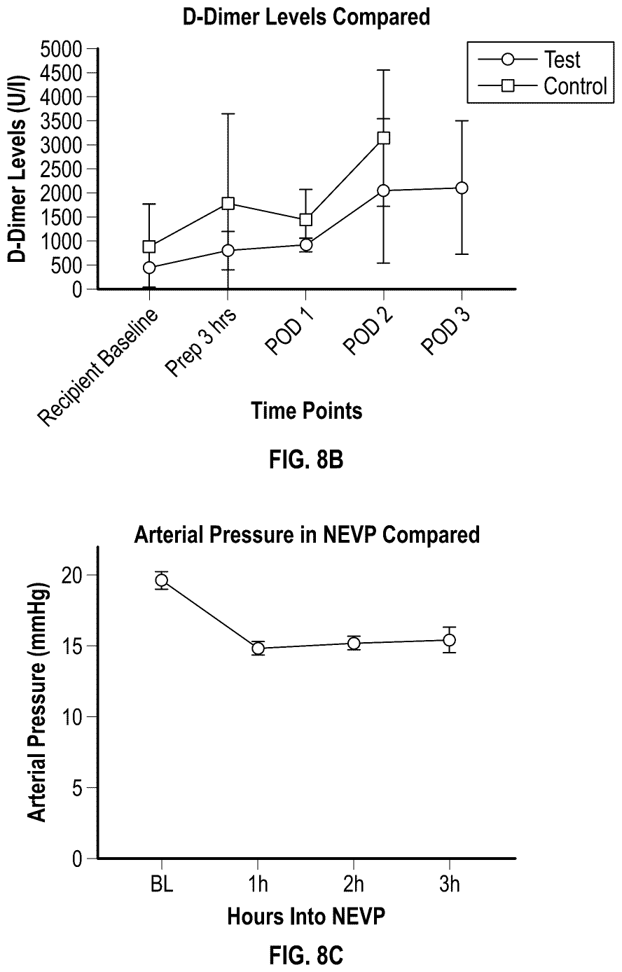

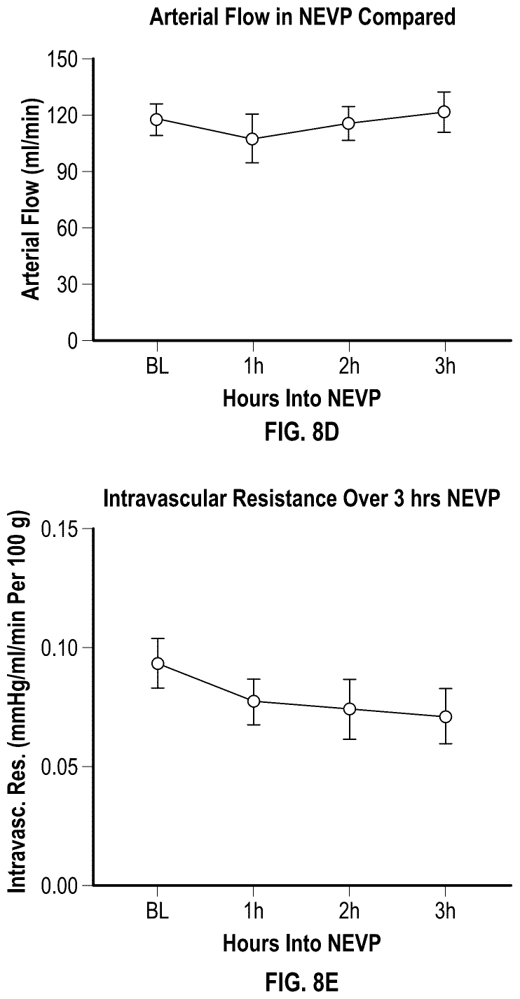

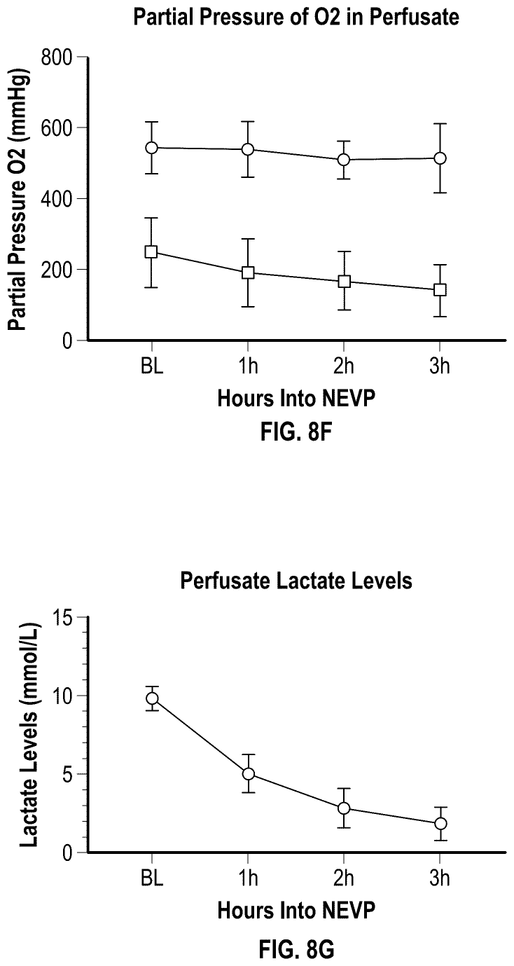

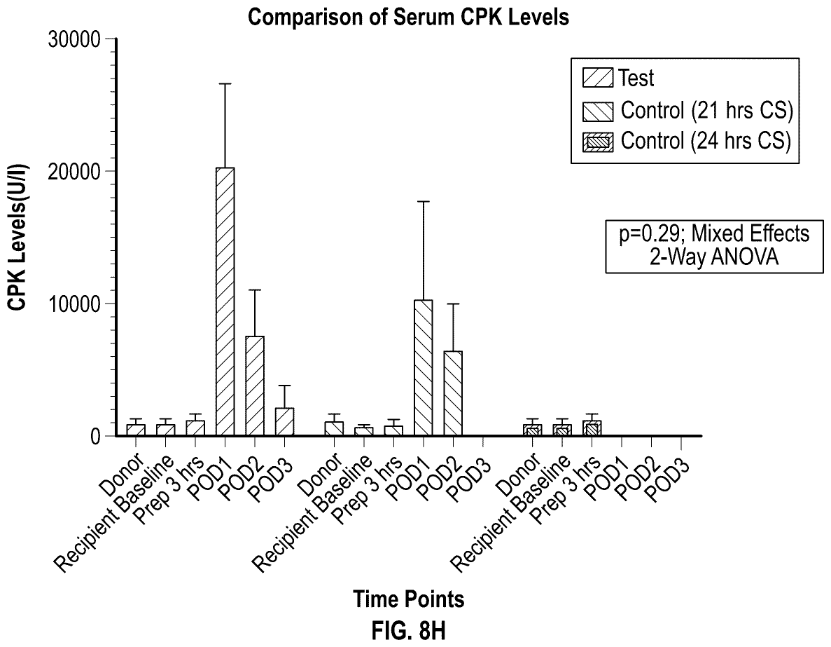

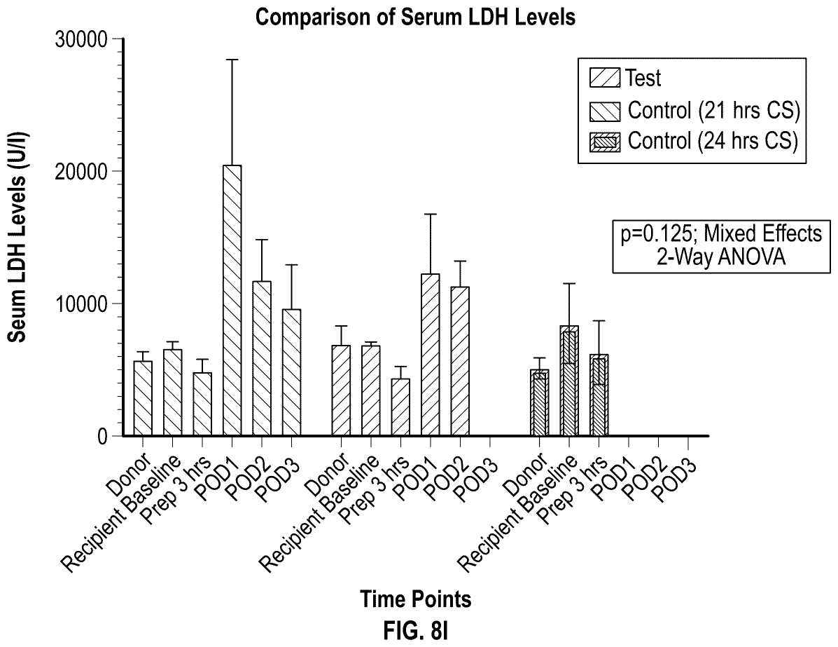

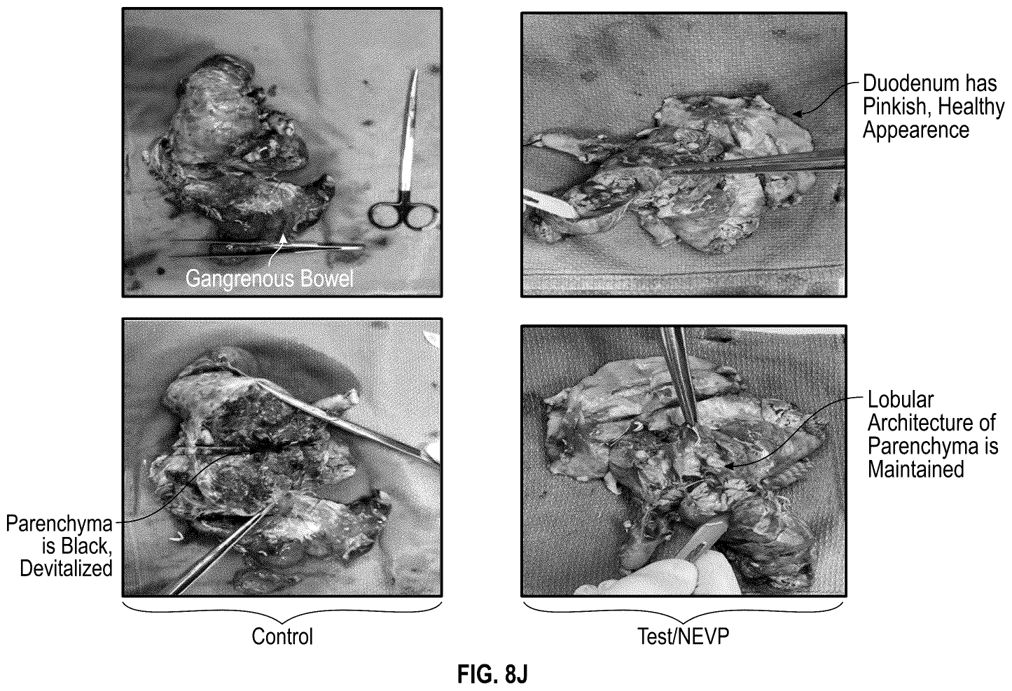

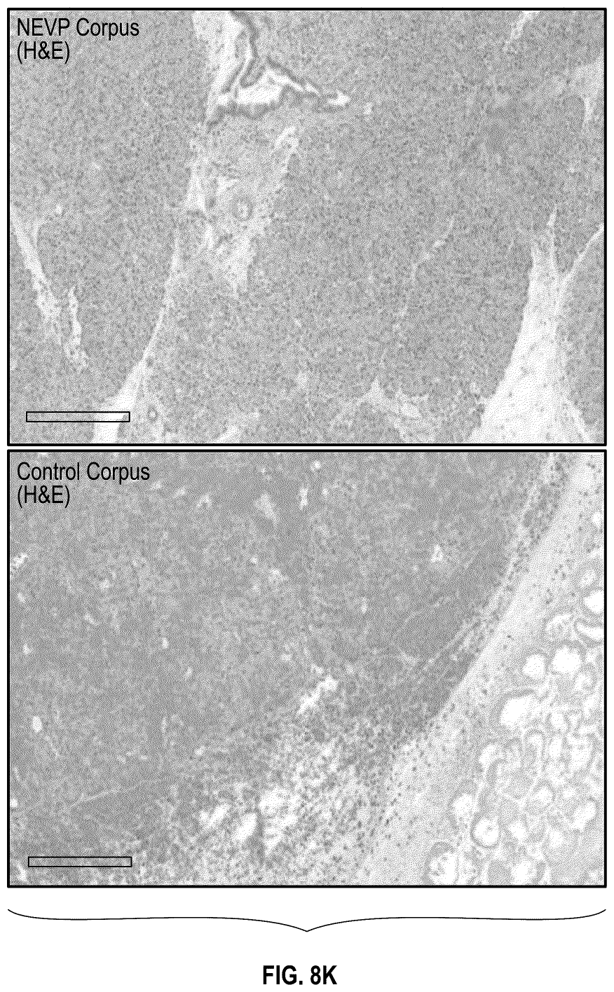

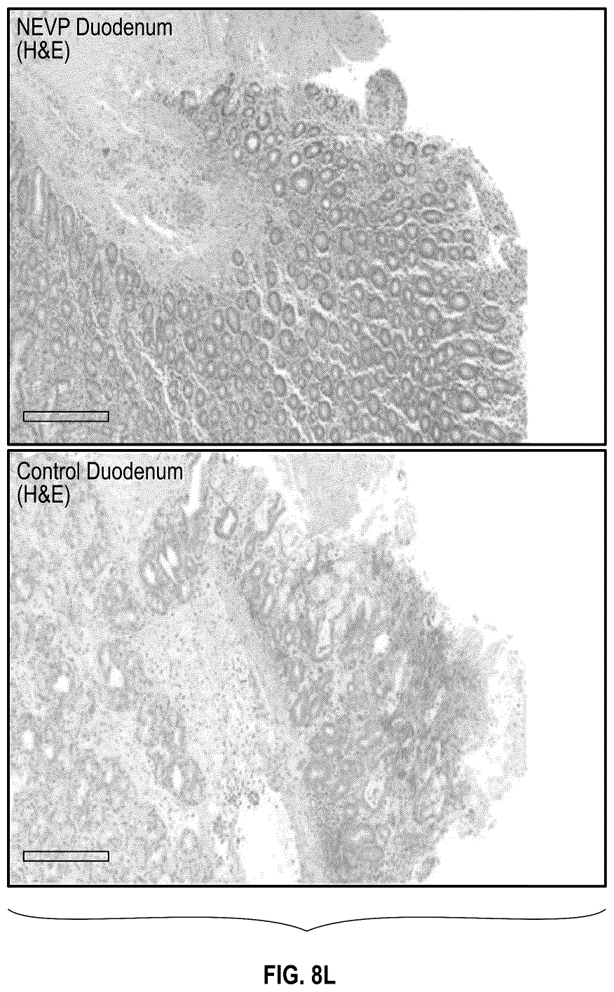

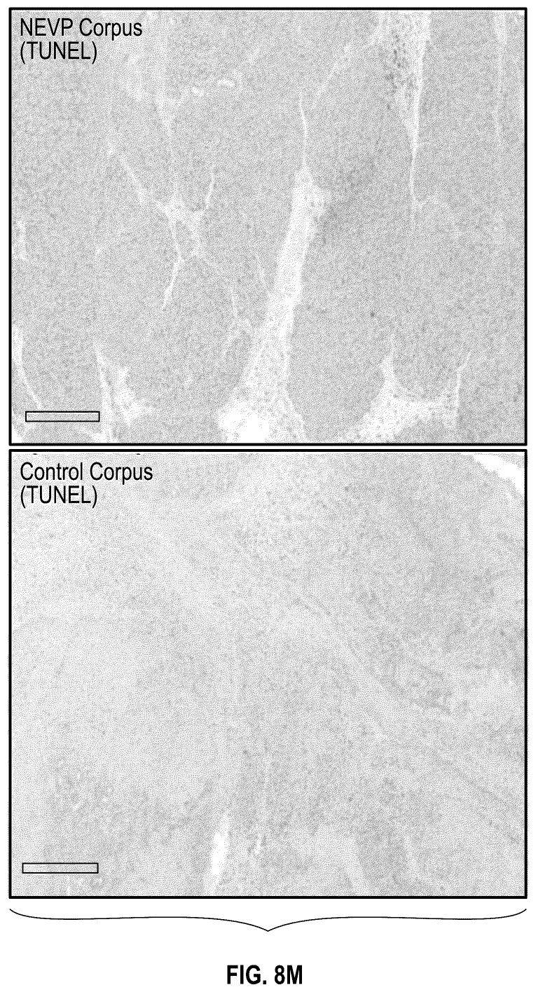

The experimental protocol is illustrated in FIG. 8A. Pancreatoduodenal grafts were procured from the donor pig (minimal warm ischemia/heart beating donation model) and were stored for ≥21 h in UW solution at 4 degrees Celsius in insulated organ container (Day 1). The recipient pig (survival animal) was pancreatectomized (Iatrogenic Diabetes) the following day (Day 2) and the grafts retrieved above were implanted after 21 to 24 h of either cold storage (CS) alone (in control arm) or subjected cold storage plus to 3 h of NEVP followed by implantation (in test arm). The recipient animals in both groups were followed for up to 3-days (72 h) after transplantation. An intravenous glucose tolerance test (IVGTT) was performed on day 3 on the animals that survived. The animals were subsequently euthanized using established humane protocols. Both the groups (control and test) were performed alternately in sequence by the same surgeon (SR) and first assistant (CP) throughout the study period.

The anesthetic and surgical procedure in the donor operation were performed according to a protocol similar to those described in the preceding examples. A policy of minimal handling of the native pancreas was followed to ensure a minimally inflamed graft at the end of the operation. After systemic administration of heparin (500 IU/kg BW) through the central venous catheter, blood was drained and collected (usually 800-1000 ml) in bags containing Citrate Phosphate Dextrose Saline Adenine Glucose-Mannitol (CPD/SAG-M), used later as a component in the perfusate used in NEVP. This was followed by cross clamping of the suprahepatic abdominal aorta and injection of potassium chloride (10 ml) to induce cardiac death (minimum warm ischemia). Immediately after this, cold flushing with 1 L Ringer lactate (primed with 10000 IU Heparin), followed by 1 L of UW solution (primed with 10000 IU Heparin) and venting out of the blood through a lateral opening in the portal vein and infra-hepatic inferior vena cava (IVC), were performed. This was followed by dissection of the graft en masse with the spleen, surrounding fasciae, and retroperitoneal tissues and intact aorta, taking care to preserve the coeliac trunk and the superior mesenteric branches. The graft was subsequently flushed with 500 ml of UW solution and stored in an iced organ box at 4 degrees Celsius for ≥21 h (24 h in first 2 cases and 21 h in the rest).

Perfusion was performed using the described system (see, e.g., system 100 shown in FIG. 1). The settings and components that were in this example are detailed in Table 7. Oxygen/carbon dioxide was provided continuously throughout the perfusion at a concentration of 91%/9% and at a rate of 2 L/min to augment the vascular flow of the graft (vasoconstriction due to prolonged cold storage) by leveraging the anti-inflammatory and vasodilatory effects of higher carbon dioxide concentration. For the dialysate, a 1.6 g/L concentration of salt was used to reduce edema.

TABLE 7
Perfusion settings and components (Example 4)

| | | Pressure, flow, and temperature |
|---|---|---|
| Perfusate (1X) | Dialysate (per 1 L) | settings |
| RL: 200 ml | NaHCO₃ (8.4%): 27 ml | Arterial pressure: 20-25 mmHg in first |
| | | 30 mins, followed by 15-17 mmHg (rest |
| | | of 3 hrs) |
| Steen's solution: 150 ml | KHCO₃ (8.4%): 3 ml | Arterial flow: 90-120 ml/hr |
| Leucocyte depleted red | Commercial | O2/CO2 conc: 91%/9%; 2 L/min |
| cell concentrate: 125 ml | hemodialysis | |
| | concentrate: 22 ml | |
| DRO water: 27 ml | NaCl: 1500 mg | Temperature of organ chamber: 37° C. |
| NaHCO₃ (8.4%): 8 ml | Sodium pyruvate: 27.5 | Temperature of the perfusion reservoir: |
| | mg | 36-37° C. |
| Calcium gluconate | All of the above to be | |
| (10%): 1.8 ml | mixed in DRO water | |
| Heparin (10000IU/10 | (solvent) to prepare a | |
| ml): 1 ml | final solution of 3 L | |
| Solu-Medrol: 250 mg | | |
| Aprotinin (Protease | | |
| inhibitor): 30 ml (15 mg) | | |
| Epoprostenol infusion: 8 | | |
| ml/hr (0.5 mg dissolved | | |
| in 250 ml RL) | | |
| Aprotinin infusion: 10 | | |
| ml/hr (5 mg/hr) | | |

At the back-table, all arterial branches were tied off and spleen was removed. Next, the aorta was cannulated using ¼″×⅜″ cannula (in the NEVP group). The portal vein was left open into the organ chamber, without cannulation. The distal duodenal end was also cannulated using a Malecot catheter to allow for enteric output measurements during perfusion (in the NEVP group). The graft was flushed with 300 ml of 5% Human serum albumin (HSA), prior to placing on pump and with 500 ml UW solution after off-pump before implantation (NEVP group). Graft edema during NEVP was assessed hourly on a semiquantitative scale from 0 to 3 (0-no edema, 1-mild edema, 2-moderate edema, 3-severe edema) and recorded.

In the recipient operations, broad spectrum antibiotics (Metronidazole 500 mg and Cefazolin 1 gm) and proton pump inhibitor (Pantoprazole 20 mg IV) were administered at induction. The surgery was comprised of two parts: pancreatectomy and graft implantation. Surgery started by fascial dissection along the groove between pancreatic head (duodenal lobe), duodenojejunal flexure, and the transverse colon. The duodenal lobe was mobilized from the underlying main portal vein trunk and the pancreatic tail (splenic lobe) was mobilized from the underlying splenic vein and spleno-portal junction. The pancreatic duct was identified, ligated, and divided, and the pancreatectomy was completed by removing the native pancreas en masse. After removing the graft from ice (Control group) or from the NEVP machine and flushing with UW solution (Test group), the recipient IVC was partially occluded using the side biting Satinsky clamp and venous anastomosis performed with the graft portal vein in an end-side continuous fashion. This was followed by arterial anastomosis between the graft aorta (proximal end) and the recipient aorta in an end-side continuous fashion using the Parachute technique. After securing an adequate hemostasis with Tranexamic acid and stabilizing hemodynamics by adjusting the inotropic infusion, bowel anastomosis was performed in a side-to-side continuous fashion between the graft duodenum and recipient jejunal loop. Abdominal closure was performed in two layers (rectus sheath followed by skin) in a continuous fashion. The central venous catheter was secured in the neck by creating a subcutaneous tunnel as described elsewhere by our group (15). The animal was transferred to the housing facility, extubated, and monitored for the next 72 hours (3-days).

For the test arm, blood gas analyses of the perfusate were performed hourly during NEVP. A part of each blood sample retrieved from the donor and recipient at different time points of the experiment was centrifuged, and supernatant stored at −80° C. for later analysis. For amylase, lipase, lactate dehydrogenase (LDH) and creatine phosphokinase (CPK) measurements, samples were sent to the Toronto General Hospital Core Laboratory for analysis with the Abbott Architect Chemistry Analyzer using the manufacturer's reagents. Coagulation profile (Prothrombin time, International normalised ratio/INR and D dimer) was performed for all recipients at 3 hrs after reperfusion and daily till the day of euthanasia. An IVGTT was performed at 72 hrs after transplantation (or at euthanasia, whichever earlier), by administrating 50 ml of Dextrose 50% (Baxter Corporation, Mississauga, Canada) to the recipient animals. Glucose levels were monitored for two hours and samples were taken at multiple timepoints (0-120 mins). For measurement of C-peptide, enzyme linked immunosorbent assays kit (R&D Systems, Toronto, Canada and Mercodia, Winston Salem, United States) were used according to manufacturer's instructions.

Biopsies were taken from all grafts in both the groups before implantation (Sham: after 21 h CS for control group and after 3 h of NEVP for the NEVP group) and 1 h after reperfusion. At sacrifice, four biopsies were taken from the pancreato-duodenal graft, which included one from each region in the pancreas and one from the duodenum. The graft was split in four regions. All samples were placed in 10% neutral buffered formalin and transferred to 70% alcohol after 36-48 h. Following paraffin embedding and sectioning (3-μm), hematoxylin and eosin (H&E) stained sections were used to score fat and parenchyma necrosis as well as islet cell integrity on a semi-quantitative scale from 0 to 3 (0-no changes, 1-mild changes, 2-moderate changes, 3-severe changes) by a pathologist blinded to the experimental groups. Additionally, duct inflammation and the integrity of islet cells were assessed (per 40 high power fields). Terminal deoxynucleotidyl transferase dUTP nick end labeling (TUNEL) and Caspase staining were also performed additionally and graded (<30%, 30-60%, and >60%). Also, sections of the tissues were stored separately in RNA later solution at 4 degrees Celsius and snap frozen in liquid nitrogen and stored at minus 80 degrees Celsius.

### Analysis

The continuous variables were expressed as mean±SD (range) and categorical variables were expressed as percentages. Mixed effect analysis using 2-way ANOVA was performed for the continuous variables across different timepoints. Kaplan-Meier survival curves were plotted for both the groups and compared using the log rank test. A p-value of <0.05 was set as statistically significant. All analysis was done using GraphPad Prism (version 9.5.1) software.

### Results

There was a total of 11 experiments in the entire cohort. There were 6 in the control arm (n=2: 24 h CS alone and n=4: 21 h cold storage alone) and 5 in the NEVP arm (21 h CS followed by 3 h of NEVP). The first 2 experiments (24 h CS alone) were carried out on a pilot trial basis and the CS duration was decreased to 21 h subsequently for the next 4 in the control arm. The 3-day survival was 60% (n=3) in the NEVP group vs 0% in the control (p=0.008). None of the animals survived beyond 3 h of reperfusion in the 24 h CS control group (n=2); both animals presented a disseminated intravascular coagulopathy (DIC) like clinical picture, diffuse bleeding, and hemorrhagic shock. D-dimer levels (as a marker for DIC) were assessed for the test and control groups (FIG. 8B). The mean graft weight at retrieval was 180.6±17.47 g, which increased to 276.8±49.91 g after 3 h of NEVP, with an average increase of 57.56±26.75%.

A graft appearance comparison was performed after 60 minutes of reperfusion in the NEVP and control group. Patchy subcapsular hemorrhages and grade 2-3 oedema were seen in all grafts in the NEVP group, compared to grade 1-2 oedema and a more congested dusky appearance of the duodenum in the control group.

The trend of arterial flow and the intravascular resistance [(arterial pressure×100/arterial pressure) per 100 gm of tissue weight] over 3 h of NEVP for the test group was studied. The mean arterial pressure at baseline was 17±2.1 mmHg (mean arterial flow of 118±9.5 ml/min) and was 15.4±1.2 mmHg (mean arterial flow of 122±8.4 ml/min) at the end of 3 hrs. The trend of partial pressure of oxygen (arterial and venous) and mean lactate levels in the perfusate was assessed over 3 h of NEVP and revealed a good oxygen extraction ratio. Plots showing measurements of arterial pressure, arterial flow, intravascular resistance, partial pressure of oxygen, and perfusate lactate levels are shown in FIGS. 8C-8G.

There was no significant difference in mean blood lactate and glucose levels at any time point compared between the two groups (p=0.32 and 0.16 respectively). The mean amylase levels were 10912±4172.8 U/1 on POD (post-operative day) 1 in NEVP group compared to 10678±7182.2 U/1 in control group, which decreased to 4757.3±3022.8 U/1 on POD 3 for the former (p=0.56). The serum CPK and LDH levels were also compared between the two groups, as shown in FIG. 8H and FIG. 8I, respectively. Endocrine function of the graft was assessed by the IV glucose challenge test (IVGTT) and C-peptide levels for the NEVP group. The glucose levels peaked to a mean of 15.16±5.36 mmol/1 at 10 mins and dropped to 5.76±6.3 mmol/1 (normoglycemic) at 120 mins in the NEVP group. None of the controls survived until 72 h for an accurate comparison of the IVGTT trend with the NEVP group. However, in the 2 cases that survived until 48-50 h, an IVGTT performed before the sacrifice revealed a severely hypoglycemic trend.

FIG. 8J shows photographs comparing the gross morphology of the grafts in the control group and in the NEVP group. The duodenum was preserved with a good vascular integrity in the NEVP group, while it showed complete transmural gangrene with impending perforations in the control group. There was preservation of 60-70% of the pancreatic parenchyma in four cases of the NEVP group and only one case in the control group. Table 8 shows a comparison of the histological grading of the parenchyma, duct, and islets between two cases in both groups.

TABLE 8
Histological grading of the parenchyma, duct, and islets comparison (Example 4)

| | H&E | | | | | | TUNEL |
|---|---|---|---|---|---|---|---|
| | Fat | | | Duct | | Islets | Staining |
| Group | necrosis | Parenchyma | Hemorrhage | integrity | Autolysis | (*4X) | percent |
| Test 1 | 0 | 1 | 0 | 1 | 1 | 1 | NA |
| (Prep 60 | | | | | | | |
| mins) | | | | | | | |
| Control | 1 | 2-3 | 1 | 1 | 1 | 2 | NA |
| 1 (Prep | | | | | | | |
| 60 mins) | | | | | | | |
| Test 2 | 1-2 | 3 | 1 | 0 | 1 | 1 | NA |
| (Prep 60 | | | | | | | |
| mins) | | | | | | | |
| Control | 1 | 1 | 0 | 1 | 1 | 3 | NA |
| 2 (Prep | | | | | | | |
| 60 mins) | | | | | | | |
| Test 1 | 1 | 1 | 0 | 0 | 0 | 2 | 30-60% |
| (Corpus | | | | | | | |
| sac) | | | | | | | |
| Control | 1-2 | 3 | 2-3 | 0 | 2 | 0 | >60% |
| 1 | | | | | | | |
| (Corpus | | | | | | | |
| sac) | | | | | | | |
| Test 2 | 1 | 1-2 | 1 | 1 | 0 | 2 | 30-60% |
| (Corpus | | | | | | | |
| sac) | | | | | | | |
| Control | 1-2 | 2-3 | 2 | 1 | 1 | 1 | 30-60% |
| 2 | | | | | | | |
| (Corpus | | | | | | | |
| sac) | | | | | | | |
| Test 1 | NA | 1 | 1 | NA | 1 | NA | NA |
| (Duod | | | | | | | |
| sac) | | | | | | | |
| Control | NA | 3 | 3 | NA | 3 | NA | NA |
| 1 (Duod | | | | | | | |
| sac) | | | | | | | |
| Test 2 | NA | 0-1 | 1 | NA | 0 | NA | NA |
| (Duod | | | | | | | |
| sac) | | | | | | | |
| Control | NA | 3 | 3 | NA | 3 | NA | NA |
| 2 (Duod | | | | | | | |
| sac) | | | | | | | |

H&E and TUNEL staining of the sections revealed a marked transmural necrosis with ischemic changes in the duodenum in both the controls, with relatively well-preserved architecture of parenchyma and duodenum in the NEVP groups, with no evidence of clots or microthrombi in the parenchyma, as shown in FIGS. 8K-8M.

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A normothermic machine perfusion method for a pancreas, the method comprising:
oxygenating a perfusate contained in a venous reservoir such that a ratio of oxygen to carbon dioxide in the oxygenated perfusate is approximately 90%/10%;
pumping a first portion of the oxygenated perfusate from the venous reservoir, through a dialysis filter, and back to the venous reservoir;
infusing a dialysate comprising a salt and glucose, into the first portion of the oxygenated perfusate as the first portion is pumped through the dialysis filter, wherein a concentration of glucose in the dialysate is less than 8 mmol/L;
pumping a second portion of the oxygenated perfusate through an arterial filter and through a pancreas graft; and
pumping venous outflow from the pancreas graft to the venous reservoir.

2. The method of claim 1, wherein a concentration of salt in the dialysate is between 0.5 g/L and 5 g/L.

3. The method of claim 2, wherein the concentration of salt in the dialysate is approximately 1.5 g/L.

4. The method of claim 1, wherein the concentration of glucose in the dialysate is less than 6 mmol/L.

5. The method of claim 4, wherein the concentration of glucose in the dialysate is approximately 5.5 mmol/L.

6. The method of claim 1, wherein the dialysate is infused at a rate of 1 L/hr.

7. The method of claim 1, comprising adding a bolus of a vasodilator to the second portion of the oxygenated perfusate after the second portion is pumped through the arterial filter.

8. The method of claim 7, wherein the vasodilator is a calcium channel blocker.

9. The method of claim 7, wherein the bolus is 5 mg/2 mL.

10. The method of claim 1, wherein the second portion of the oxygenated perfusate is pumped through the pancreas graft at a rate greater than or equal to 90 mL/min and less than or equal to 125 mL/min.

11. The method of claim 1, wherein the perfusate comprises at least one antibiotic.

12. The method of claim 11, wherein the at least one antibiotic comprises metronidazole.

13. The method of claim 11, wherein the at least one antibiotic comprises cefazolin.

14. The method of claim 11, wherein the at least one antibiotic comprises metronidazole and cefazolin, wherein a ratio of an amount of metronidazole to an amount of cefazolin is 0.5.

15. The method of claim 1, comprising extracting islets from the pancreas graft following perfusion.

16. The method of claim 1, wherein the pancreas graft was held in cold storage for at least 15 hours prior to perfusion.

17. The method of claim 16, comprising transplanting at least a portion of the pancreas graft following perfusion.

18. The method of claim 1, comprising:
monitoring an arterial pressure in the pancreas graft as the second portion of the oxygenated perfusate is pumped through the graft; and
adjusting a flow rate of the second portion of the oxygenated perfusate through the pancreas graft based on the arterial pressure.

19. The method of claim 18, wherein the flow rate of the second portion of the oxygenated perfusate is adjusted such that the arterial pressure is maintained between 15 mmHg and 27 mmHg.

20. A system for normothermic machine perfusion of a pancreas, the system comprising:
a perfusate;
a venous reservoir for containing the perfusate;
an oxygenator connected to the venous reservoir and configured to produce oxygenated perfusate, wherein a ratio of oxygen to carbon dioxide in the oxygenated perfusate is approximately 90%/10%;
a dialysis filter connected to the venous reservoir and configured to infuse a dialysate comprising a salt and glucose into a first portion of the oxygenated perfusate;
an arterial filter for filtering a second portion of the oxygenated perfusate;
a chamber for containing a pancreas graft connected to the venous reservoir and the arterial filter; and
a pump for transporting the perfusate from the venous reservoir to the oxygenator, transporting the first portion of the oxygenated perfusate through the dialysis filter, transporting the second portion of the oxygenated perfusate through the arterial filter and through the pancreas graft in the chamber, and transporting venous outflow from the pancreas graft in the chamber to the venous reservoir.

21. The system of claim 20, wherein a concentration of salt in the dialysate is between 0.5 g/L and 5 g/L.

22. The system of claim 21, wherein the concentration of salt in the dialysate is approximately 1.5 g/L.

23. The system of claim 20, wherein the concentration of glucose in the dialysate is less than 6 mmol/L.

24. The system of claim 23, wherein the concentration of glucose in the dialysate is approximately 5.5 mmol/L.
